(19) United States
(12) Patent Application Publication
(10) Pub. No.: US 2025/0197261 A1
(43) Pub. Date: Jun. 19, 2025

(54) WASTEWATER TREATMENT USING COMPOSITE BIOFILM CARRIERS

(71) Applicant: UNIVERSITY OF SOUTH FLORIDA, Tampa, FL (US)

(72) Inventors: John KUHN, Tampa, FL (US); Sarina ERGAS, Tampa, FL (US); Susieanna PERSAUD, Tampa, FL (US); Tione GRANT, Tampa, FL (US); Sheyla CHERO-OSORIO, Tampa, FL (US)

(21) Appl. No.: 18/979,417

(22) Filed: Dec. 12, 2024

Related U.S. Application Data
(60) Provisional application No. 63/609,857, filed on Dec. 13, 2023.

(51) Int. Cl. C02F 3/02; C02F 3/28; C02F 3/30; C02F 3/34; C02F 101/16

(52) U.S. Cl. CPC C02F 3/02; C02F 3/28; C02F 3/30; C02F 3/34; C02F 2101/16

(57) ABSTRACT

The present disclosure provides composite material, reactors, and methods for wastewater treatment. In particular embodiments, a biofilm carrier with incorporated zeolites was prepared. The present composite material combines the ion exchange properties of zeolites with the surface advantages of biofilm carriers to provide increased ammonium removal rates in wastewater by encouraging microbial growth.

### CROSS-REFERENCE TO RELATED APPLICATIONS

This application claims the benefit of and priority to U.S. Provisional Application No. 63/609,857, filed Dec. 13, 2023, the content of which is hereby incorporated by reference in its entirety.

### STATEMENT REGARDING FEDERALLY SPONSORED RESEARCH

This invention was made with government support under Grant Number 2000980 awarded by the National Science Foundation. The government has certain rights in the invention.

### BACKGROUND OF THE INVENTION

Nitrogen discharges from wastewater is a global issue and with increased urbanization as well as industrialization, it has become even more essential to develop more efficient wastewater treatment systems. The dominant form of nitrogen in wastewater is ammonium. Biological oxidation of ammonium to nitrite, or nitritation, is the first step in biological nitrogen removal processes. Nitrite can be further transformed to harmless nitrogen gas, though several pathways, including conventional biological nitrification/denitrification, shortcut nitrogen removal (also known as nitrate shunt) and partial nitritation/anammox (also known as deammonification). If left untreated, nitrogen can cause toxicity to aquatic life, unsafe changes in water quality, and eutrophication.

Biofilm carriers can help to improve the efficiency of traditional activated sludge wastewater treatment systems by reducing operating costs and reducing hydraulic retention time. Biofilm carriers also promote the growth of biomass by providing solid media that the microbes can adhere to and promote the production of extracellular polymeric substances. Microbes growing as biofilms are less susceptible to being washed out of bioreactors because of high flow rates or low temperatures. They are also able to develop stable community structures critical to biological nitrogen removal processes, where the waste products from one microbial group (e.g., nitrite) is the substrate for another microbial group.

Zeolites have been utilized in wastewater treatment in the past for ammonium removal due to their low cost and cation exchange properties. These ion exchange materials are also not toxic to microorganisms typically used in biological wastewater treatment and usually have high selectivity for ammonium to other competing cations present in wastewater. However, they are normally regenerated using high concentration brine solutions, resulting in production of a secondary waste stream that needs to be treated or disposed of. There remains need for alternative nitrogen removal methods for efficient and cost-saving treatment of wastewater.

### SUMMARY OF THE INVENTION

In one aspect, the present disclosure provides a composite. The composite includes a polymeric hydrogel and an ammonium exchange zeolite attached to the hydrogel, wherein the polymeric hydrogel includes polyvinyl alcohol (PVA) and a second polymer component selected from the group consisting of sodium alginate (SA), polyacrylamide (PAM), chitosan, gelatin, carrageenan, polyurethane, poly(lactic acid), poly(N-isopropylacrylamide) (PNIPAAm), polyethylene glycol, polyacrylic acid (PAA), and polyvinylpyrrolidone (PVP). In some embodiments, the second polymer component is sodium alginate. In some embodiments, the ammonium exchange zeolite is encapsulated in the polymeric hydrogel. The composite shape may be selected from spherical, cylindrical, ring-shaped, hexagonal, star, disc-shaped, spiral, helical, tetrahedral, octahedral, pyramidal, or prismatic. The ammonium exchange zeolite may include analcite, apophyllite, chabazite, clinoptilolite, erionite, faujasite, heulandite, inesite, laumontite, mordenite, natrolite, phillipsite, stilbite, or a mixture thereof.

In some embodiments, the composite further includes an ammonium oxidizing biofilm attached to the hydrogel. In some embodiments, the ammonium oxidizing biofilm includes ammonium-oxidizing microorganisms (AOM), anaerobic ammonium oxidation (anammox) bacteria, or a combination thereof.

In another aspect, the present disclosure provides a reactor for removing ammonium ions from wastewater, comprising the composite as described herein.

In another aspect, the present disclosure provides a reactor for removing ammonium ions from wastewater. The reactor includes a polymeric hydrogel carrier; an ammonium exchange zeolite attached to the polymeric hydrogel carrier; and an ammonium oxidizing biofilm attached to the polymeric hydrogel carrier. In some embodiments, the polymeric hydrogel carrier includes polyvinyl alcohol (PVA), polyethylene glycol (PEG), alginate, sodium alginate (SA), polyacrylamide (PAM), chitosan, gelatin, carrageenan, polyurethane, poly(lactic acid), poly(N-isopropylacrylamide) (PNIPAAm), carrageenan, hyaluronic acid, polyacrylic acid (PAA), polyvinylpyrrolidone (PVP), or a combination thereof.

In some embodiments, the reactor further includes a container, wherein the polymer carrier having the ammonium exchange zeolite and the ammonium oxidizing biofilm attached thereto is placed inside the container, and wherein the container is configured to introduce wastewater to contact the ammonium exchange zeolite and the ammonium oxidizing biofilm.

In some embodiments, the reactor is selected from a moving bed biofilm reactor (MBBR), a membrane bioreactor (MBR), an anaerobic baffled reactor, a sequencing batch biofilm reactor (SBBR), a fluidized bed reactor, or an integrated fixed film activated sludge (IFAS) reactor.

In another aspect, the present disclosure provides a wastewater treatment system comprising the reactor described herein. In some embodiments, the system includes a control unit for introducing wastewater into the reactor, monitoring the removal of ammonium ions from the wastewater, and/or discharging wastewater after treatment.

In another aspect, the present disclosure provides a method of treating wastewater that includes ammonium ions. The method includes contacting the wastewater with the composite as described herein for a treatment duration, thereby concentration of the ammonium ions in the wastewater is reduced.

In another aspect, the present disclosure provides a method of treating wastewater that includes ammonium ions. The method includes introducing the wastewater into the reactor as described herein for a treatment duration, such that the wastewater contacts the ammonium exchange zeolite and the ammonium oxidizing biofilm attached to the polymer carrier, thereby concentration of the ammonium ions in the wastewater is reduced.

In some embodiments, the ammonium ions are absorbed by the ammonium exchange zeolite, which is then regenerated by the ammonium oxidizing biofilm via biological oxidation of the absorbed ammonium ions. In some embodiments, the wastewater includes ground water, lake water, river water, municipal wastewater, industrial wastewater, landfill leachate, or a combination thereof.

The present disclosure also provides a method of preparing a composite including a polymeric hydrogel and an ammonium exchange zeolite attached to the polymeric hydrogel, wherein the polymeric hydrogel comprises polyvinyl alcohol (PVA) and a second polymer component. The method includes mixing the polyvinyl alcohol, the second polymer component, and the ammonium exchange zeolite in water to form a mixture; and adding a crosslinking solution to the mixture, thereby forming the composite. In some embodiments, the second polymer component is selected from a group consisting of sodium alginate (SA), polyacrylamide (PAM), chitosan, gelatin, carrageenan, polyurethane, poly(lactic acid), poly(N-isopropylacrylamide) (PNIPAAm), polyethylene glycol, polyacrylic acid (PAA), and polyvinylpyrrolidone (PVP). In some embodiments, the weight ratio of polyvinyl alcohol and the second polymer component is between 5:1 and 1:5. In further embodiments, the weight ratio of polyvinyl alcohol and the second polymer component is about 1:1.

In yet another aspect, the present disclosure provides a composite prepared by the preparation method as described herein.

### BRIEF DESCRIPTION OF DRAWINGS

FIG. 1 is a schematic of the nitrogen cycle.

FIG. 2 shows hydrogel carriers using crushed versus unmodified chabazite.

FIG. 3 shows sphere hydrogel carriers.

FIG. 4 illustrates batch experiment with AOM outside hydrogel carrier.

FIG. 5 illustrates batch experiment with AOM inside hydrogel carrier.

FIG. 6 shows NH₄⁺ removal using hydrogels with crushed versus unmodified chabazite.

FIG. 7 shows ion exchange on hydrogel with unmodified zeolite.

FIG. 8 shows ion exchange on hydrogel with crushed zeolite.

FIG. 9 shows PFO kinetic model of disk hydrogel carrier.

FIG. 10 shows PSO kinetic model of disk hydrogel.

FIG. 11 shows isotherm models for disk carriers with chabazite in wastewater solution.

FIG. 12 shows disk vs. sphere hydrogel carriers.

FIG. 13 shows batch test concentration for AOM and chabazite outside the carrier.

FIG. 14 shows batch test concentration for AOM and chabazite without carrier.

FIG. 15 shows batch test concentration for chabazite with carrier (no AOM).

FIG. 16A shows comparison of ammonium removal in batch test. FIG. 16B shows comparison of carrier performance in small-scale tests.

FIG. 17 shows batch test Nitrogen concentration for AOM and chabazite inside carrier.

FIG. 18 shows small scale test using AOM and chabazite inside disk carrier.

FIG. 19 shows a polyethylene carrier.

FIG. 20 shows ammonium removal using PVA-SA carriers versus PE carriers.

FIG. 21 shows the steps in a typical IX-PN/A treatment cycle: ion exchange with mainstream wastewater, sidestream addition, and bioregeneration.

FIG. 22 shows the results of IX modelling for the breakthrough curve in a IX-PN/A treatment for mainstream wastewater. The experimental data fits the Yan model as a function of flow rate, chabazite mass, and initial ammonium concentration.

FIG. 23A shows the performance of IX-PN/A treatment over a period of 20 treatment cycles (˜500 days), as measured by the concentration profiles of ammonium, nitrite, and nitrate. FIG. 23B shows concentrations of ammonium (NH4+) and sodium (Na+) during a typical IX (left)-PNA (right) treatment cycle.

### DETAILED DESCRIPTION OF THE INVENTION

Before the present invention is described in further detail, it is to be understood that the invention is not limited to the particular embodiments described. It is also to be understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising”, “including”, or “having” should be interpreted as referring to elements, components, or steps in a non-exclusive manner, so the referenced elements, components, or steps may be combined with other elements, components, or steps that are not expressly referenced. Embodiments referenced as “comprising”, “including”, or “having” certain elements are also contemplated as “consisting essentially of” and “consisting of” those elements, unless the context clearly dictates otherwise. It should be appreciated that aspects of the disclosure that are described with respect to a system are applicable to the methods, and vice versa, unless the context explicitly dictates otherwise.

Numeric ranges disclosed herein are inclusive of their endpoints. For example, a numeric range of between 1 and 10 includes the values 1 and 10. When a series of numeric ranges are disclosed for a given value, the present disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

The word “exemplary” is used herein to mean serving as an example, instance, or illustration. Any aspect or design described herein as “exemplary” is not necessarily to be construed as preferred or advantageous over other embodiments or designs.

Furthermore, the disclosed subject matter may be implemented as a system, method, apparatus, or article of manufacture using standard engineering techniques to produce hardware, firmware, software, or any combination thereof to implement embodiments detailed herein.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

Unless specified or limited otherwise, the terms “connected,” and “coupled” and variations thereof are used broadly and encompass both direct and indirect mountings, connections, supports, and couplings. Further, “connected” and “coupled” are not restricted to physical or mechanical connections or couplings. As used herein, unless expressly stated otherwise, “connected” means that one element/feature is directly or indirectly connected to another element/feature, and not necessarily electrically or mechanically. Likewise, unless expressly stated otherwise, “coupled” means that one element/feature is directly or indirectly coupled to another element/feature, and not necessarily electrically or mechanically.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of embodiments of the methods of the invention.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

An overabundance of reactive nitrogen in wastewater can cause adverse effects if wastewater is not properly treated. Reactive nitrogen consists of all forms of nitrogen, with the exception of its gaseous atmospheric state, di-nitrogen (N₂) (Winiwarter et al., 2013). Forms of reactive nitrogen include, organic nitrogen, ammonia (NH₃), ammonium (NH₄⁺), nitrite (NO₂⁻), nitrate (NO₃⁻), nitric oxide (NO) and nitrous oxide (N₂O) (Ergas & Aponte-Morales, 2014). A major adverse effect caused by reactive nitrogen in water is eutrophication. This is the over enrichment of nitrogen, phosphorus, and other nutrients in aquatic systems, causing an increased growth of algal blooms (Burkholder et al., 2007). These algal blooms block out sunlight from sea grass, which are underwater plants that remove carbon dioxide from the atmosphere, improve water clarity by settling particles and serve as a food source to fish as well as other marine life (Cullen-Unsworth & Unsworth, 2013; Wahyudi et al., 2020). The overgrowth of algal blooms due to eutrophication has been shown to be one of the main causes of sea grass decline (Burkholder et al., 2007). The increased growth of algal blooms also causes blockages along streams that increases flooding in low lying areas and can form stagnant waterways allowing the formation of insect breeding grounds (de la Cruz et al., 2017). When algae die, bacteria decompose the remains, which utilizes dissolved oxygen causing other aquatic life such as fishes to die from an oxygen deficit (Wurtsbaugh et al., 2019). These decomposing bacteria can also lower the pH of the water and produce harmful toxins that can kill other plants and animals (Wurtsbaugh et al., 2019). Algal blooms produce toxins, such as cyanotoxins, brevetoxins and domonic acid, in water that can affect humans if left untreated, causing liver failure, nausea, and respiratory problems (Shumway, 1990). The toxins also poison shellfish and greatly affect the fishing industry (Wurtsbaugh et al., 2019). In some places, such as the USF study of the effect of harmful algal blooms on tourism in Florida, or Yellow sea China, tourism is also affected by the large amounts of algal blooms overtaking the area (Alvarez et al., 2024, Song et al., 2022).

Reactive nitrogen in wastewater is most present as total ammonia, a combination of free ammonia and ammonium ions. Ammonium can be removed using ammonia oxidizing microorganisms (AOM), which consume ammonium under aerobic conditions and produce nitrite. This can then be converted to nitrogen gas (N₂) which can be released safely to the atmosphere by anoxic bacteria such as denitrifying bacteria or anaerobic ammonia oxidizing bacteria (Anammox) (Weralupitiya et al., 2021; Zhao et al., 2022). Anammox also directly utilizes ammonium to form nitrogen gas (Chero-Osorio, 2022). Creating an environment conducive to the optimal growth and maintenance of these organisms is essential to ensure effective removal of ammonium in wastewater treatment. These types of wastewater treatment processes are biological nitrogen removal (BNR) systems.

Some BNR systems use biofilm carriers that microbes can adhere to while inside the reactors. Reactors, such as moving bed biofilm reactor (MBBR) and integrated fixed film activated sludge (IFAS) reactor, are used to help maintain optimal conditions for the microbes while incorporating the carriers. In these systems, the microbes develop as biofilms. A biofilm is a community of microbes that interact and form extracellular polymeric substances (EPS) developing a structural matrix environment that is favorable to the microbes (Chattopadhyay et al., 2022; Verma et al., 2022). EPS can store carbohydrates, proteins as well as humic components that serve as nutrients and can help protect the microbes in cases where the environment becomes toxic (Chattopadhyay et al., 2022; Verma et al., 2022). Microbes growing in biofilms are able to develop stable community structures critical to BNR processes, where the waste products from one microbial group (e.g., nitrite) is the substrate for another microbial group. MBBR and IFAS use biofilm carriers as abiotic surfaces that the biofilms can attach to during the treatment process, reducing microbial loss during transfer and increasing the concentration of these microbial communities (Chattopadhyay et al., 2022; Malovanyy et al., 2015).

Cation exchange materials, such as zeolites, can be coupled with nitrifying bacteria, such as AOM on biofilm carriers to create concentrated areas of ammonium that the microorganisms can access. This creates an environment which encourages the growth of microbes and stable development of biofilm near these areas. The nitrifying bacteria continually bioregenerates the zeolite while it (zeolite) adsorbs the ammonium ions onto its surface. This process continues until all the ammonium is eventually removed from the system. This not only lowers the cost since the ion exchange materials do not need to be chemically regenerated or disposed, but also allows the removal process to occur in the same reactor in a single step (Lahav & Green, 2000). Chabazite is a natural zeolite that is low cost and can be used for adsorption of ammonium ions in wastewater treatment due to its microporosity and high cation exchange capacity for ammonium ions (Aponte-Morales, 2015). Chabazite is naturally loaded with sodium ions which are released during the cation exchange process with ammonium ions (sodium ions desorbed while ammonium ions are adsorbed) (Aponte-Morales, 2015). Chabazite has been shown to be more selective to ammonium ions than other commonly used zeolites in wastewater treatment such as Clinoptilolite (Aponte-Morales, 2015). Chabazite has also been shown to have better sorption of ammonium ions than bentonite and biochar (Prajapati et al., 2014).

In the past, the raw ion exchange materials including chabazite were used in combination with biological processes to remove ammonium but were not utilized in biofilm carriers even though biofilm carriers have been shown to help increase the growth of biomass (Landreau et al., 2020). There are several advantages to using systems with biofilm carriers over chemical, ion exchange, and other biological wastewater treatment systems. Advantages include significantly lower operational cost, less space needs and lower energy requirements (Weralupitiya et al., 2021; Zhao et al., 2019). Bioreactors with biofilm carriers also have lower sludge production, better hydraulic retention time and development of EPS as compared to the traditional biological removal systems (Lee et al., 2020; Mahto & Das, 2022). A summary of the advantages and disadvantages of these processes is shown in Table 1.

TABLE 1
Comparison of wastewater treatment systems

| Treat- | | | |
|---|---|---|---|
| ment | | | |
| Systems | Advantages | Disadvantages | Citations |
| Biolog- | High effluent | High retention, | (Lee et al., 2020; |
| ical | quality, microbes | clogging, | Mahto & Das, 2022; |
| | reused for | microbial loss | Weralupitiya et al., |
| | cycles unlike | during transfers, | 2021; Winkler & |
| | nonbiological | sensitivity to | Straka, 2019; Zhao et |
| | systems | environment. | al., 2019) |
| Chemical | Low retention, | High cost, high | (Lee et al., 2020; |
| | simple process, | energy, additional | Mahto & Das, 2022; |
| | controlled, | steps to neutralize | Weralupitiya et al., |
| | unaffected by | pH, low effluent | 2021; Winkler & |
| | toxic conditions | quality | Straka, 2019; Zhao et |
| | | | al., 2019) |
| Ion | Low cost of | Further treatment | (Aponte-Morales, |
| exchange | material, high | needed, high | 2015; Lahav & Green, |
| | availability, | energy | 2000; Weralupitiya |
| | high selectivity | | et al., 2021) |
| Biological | Low space, high | clogging, slow | (Landreau et al., 2020; |
| systems | effluent quality, | initial | Lee et al., 2020; |
| with | low sludge | retention, | Mahto & Das, 2022; |
| carriers | production, low | | Weralupitiya et al., |
| | operational cost, | | 2021; Winkler & |
| | low hydraulic | | Straka, 2019; Zhao et |
| | retention time, | | al., 2019) |
| | high concen- | | |
| | tration of | | |
| | biomass | | |

Hydrogels can be utilized as biofilim carriers due to their physical properties. Hydrogels are hydrophilic polymer-based structures that can swell in water while maintaining their structural integrity (Morteza et al., 2016). Their flexible and elastic nature allows them to swell, while the bonds created between the crosslinked polymer chains allow them to remain mechanically intact, preventing dissolution (Ahmed, 2015; Morteza et al., 2016). Hydrogels can be physically or chemically crosslinked depending on the properties desired for their application. This includes the degree of mechanical strength and sensitivity to environmental factors such as temperature. Polyvinyl alcohol-sodium alginate (PVA-SA) hydrogel carriers are typically used in wastewater treatment for biomass immobilization. Recently, they have been incorporated for biofilm carrier applications (Gao et al., 2022). This is due to their ability to maintain high metabolic activity, resistance to typical wastewater conditions and their flexibility, allowing high concentrations of microbes to grow (Landreau et al., 2020).

Hydrogels specially the polyvinyl alcohol-sodium alginate (PVA-SA) hydrogels, were selected to be used as the biofilm carrier in this project because they have been shown to increase the ammonium removal rate in wastewater, promote the growth of microorganisms (nitrifying and Anammox) and also due to their highly porous nature (Gao et al., 2022; Landreau et al., 2020). Hydrogel carriers were expected to reduce blockage of the chabazite surface when encapsulated in the PVA-SA and allow the microbes to have easy access to these surfaces for bioregeneration of the chabazite, achieving high ammonium removal rates.

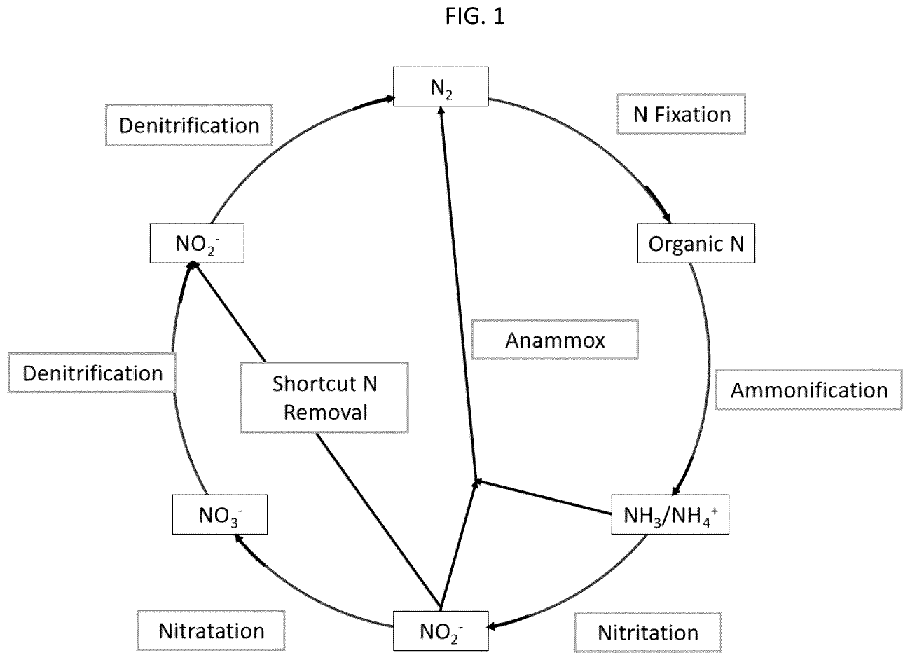

BNR systems use microorganisms to aid in the removal of nitrogen in wastewater treatment. FIG. 1 shows a brief overview of the nitrogen cycle. Nitrogen is naturally converted to ammonium by nitrogen fixing bacteria (Ergas & Aponte-Morales, 2014). This ammonium can then be used as nutrients by other organisms (Ergas & Aponte-Morales, 2014). Ammonium can be utilized by ammonium oxidizing microorganisms (AOM) to form nitrite in aerobic conditions (Aponte-Morales et al., 2018; Chero-Osorio, 2022). AOM is the combination of Ammonium oxidizing bacteria (AOB) and ammonium oxidizing archaea (AOA) (Zhao et al., 2022). The nitrite produced by AOM, can then be converted to nitrate by nitrite oxidizing bacteria (NOB) in this aerobic environment through a process called nitratation (Aponte-Morales et al., 2018; Chero-Osorio, 2022). Denitrifying bacteria then convert nitrite or nitrate into nitrogen gas under anaerobic conditions (Aponte-Morales et al., 2018; Chero-Osorio, 2022). Conversion of nitrite to nitrogen gas without first oxidizing nitrite to nitrate is called shortcut nitrogen removal or nitrate shunt (Ergas & Aponte-Morales, 2014). Anammox bacteria convert nitrite into nitrogen gas as well as convert ammonium directly into nitrogen gas (Chero-Osorio, 2022). Therefore, using a process called deammonification which utilizes partial nitrification (NH₄⁺ to NO₂) and Anammox only, ammonium can be removed in a more efficient way (Chero-Osorio, 2022). This process is done by suppressing NOB activity (Chero-Osorio, 2022). There are several advantages to reducing nitratation and inhibiting NOB growth, such as lower energy cost since less aeration is required due to only nitrite being produced by AOM (Ma et al., 2015; Winkler & Straka, 2019). There is also a lower organic carbon demand during the denitrifying step as anammox can convert nitrite to nitrogen gas without organic carbon (Chero-Osorio, 2022). Eliminating the nitratation step eliminates the need for denitrification, reducing the BNR process to a partial nitritation and anammox process (PN/A). This process saves an estimated 60% in aeration and lowers sludge production (Ma et al., 2015; Winkler & Straka, 2019). PN/A processes can have some drawbacks depending on how the system is set up as it can be difficult to maintain dissolved oxygen conditions needed to suppress the NOB growth and maintain the anammox microbes (Chero-Osorio, 2022). NOB growth can also be inhibited by free ammonia and nitrite levels, however, this also affects the deammonification process so these levels need to be controlled to ensure a balance which creates an additional challenge for this process (Chero-Osorio, 2022). FIG. 1 shows an adaptation of the nitrogen cycle and the PN/A process includes AOM, Anammox and shortcut nitrogen removal pathways (Aponte-Morales et al., 2018; Chero-Osorio, 2022).

### Composite Material

In one aspect, the present disclosure provides a composite including a polymeric hydrogel and an ammonium exchange zeolite attached to the hydrogel. The polymeric hydrogel includes polyvinyl alcohol (PVA) and a second polymer component selected from the group consisting of sodium alginate (SA), polyacrylamide (PAM), chitosan, gelatin, carrageenan, polyurethane, poly(lactic acid), poly(N-isopropylacrylamide) (PNIPAAm), polyethylene glycol, polyacrylic acid (PAA), and polyvinylpyrrolidone (PVP). In some embodiments, the second polymer component is sodium alginate.

A polyvinyl alcohol-sodium alginate (PVA-SA) hydrogel is a composite material formed by combining PVA, a water-soluble polymer, and SA, a natural polysaccharide. This hydrogel benefits from the mechanical strength of PVA and the gel-forming ability of SA, creating a material with enhanced swelling capacity, biocompatibility, and biodegradability. The resulting composite hydrogel can be formed through a variety of methods, including physical blending, chemical crosslinking, or using external agents (such as divalent cations) to enhance the properties of the individual components.

The term “ammonium exchange zeolite” as used herein refers to a zeolite material capable exchanging positively changed ions (e.g., Na⁺ or K⁺) with ammonium ion (NH₄⁺) in a solution. The ammonium exchange zeolite can be natural or synthetic. Suitable natural ammonium exchange zeolites include, for example, clinoptilolite, mordenite, erionite, chabazite, phillipsite, stilbite, analcime, and laumontite. Suitable synthetic ammonium exchange zeolites include, for example, Zeolite A (NaA). Chabazite is a low-cost zeolite with high selectivity for ammonium. In some embodiments, the ammonium exchange zeolite comprises chabazite. Zeolites may include a negatively charged framework silicate formed from interlocking tetrahedrons of SiO₄ and AlO₄. Zeolites may have relatively large spaces or channels that allow molecules to pass through.

In some embodiments, the zeolite utilized in the disclosed processes is a naturally occurring mineral, but it also can be a synthetically manufactured zeolite. Natural zeolites are much less expensive than synthetic zeolites, though synthetic zeolites would also work well in the disclosed processes and devices. Because natural sources of zeolites often contain mixtures of zeolites instead of one single zeolite and some zeolites share several common characteristics. Therefore, the term “zeolite”, as used herein, include one zeolite and a mixture of zeolites with the desired properties.

As used herein, “zeolite” includes a crystalline, micro-porous, hydrated aluminosilicate minerals of tectosilicate typetectosilicate type, i.e., a three-dimensional framework of interconnected tetrahedra, comprising aluminum, silicon, oxygen atoms, and alkali and/or alkaline earth metals. The composition of a zeolite, as used herein, is generally represented by the formula: M_{2/z}[(SiO₂)ₓ(Al₂O₃)]·nH₂O, where M is any alkali or alkaline earth atom, z is the valence of M, x is the number of Si tetrahedron (varying from 2 to 10), and n is the number of water molecules (varying from 2 to 7) contained in the voids of the zeolite.

Suitable natural forms of zeolite include, but are not limited to, analcite, apophyllite, chabazite, clinoptilolite, erionite, faujasite, heulandite, inesite, laumontite, mordenite, natrohte, phillipsite, stilbite, and mixtures thereof. In some embodiments, the zeolite is chabazite, clinoptilolite, erionite, mordenite, and mixtures thereof. In some embodiments, the zeolite is chabazite.

As described herein, the term “attachment” refers to any type of physical or chemical association between two or more substances. For example, the attachment of the ammonium exchange zeolite to the PVA-SA hydrogel can include, but not is limited to, absorption or coating of the zeolite on the surface of the hydrogel, encapsulation of the zeolite (e.g., by porous structures) inside the hydrogel, dispersal of the zeolite throughout the entire hydrogel, and chemical bonding (e.g., via ionic or covalent bonds) of the zeolite to the hydrogel.

As described herein, the term “hydrogel” or “polymeric hydrogel” refers to a network of polymer chains that are hydrophilic and capable of absorbing large amounts of water or biological fluids without dissolving. These materials are often used in a variety of applications due to their ability to maintain moisture, flexibility, and softness. Hydrogels can be made from natural or synthetic polymers and are widely used in fields such as medicine (for wound care, drug delivery, and tissue engineering), agriculture (for water retention in soil), and consumer products. Their structure allows them to swell when in contact with water, forming a gel-like consistency.

In some embodiments, the zeolite is encapsulated within the polymeric hydrogel, where the zeolite particles are physically attached to the hydrogel network. The hydrogel matrix provides structural stability, while the zeolite maintains its intrinsic capabilities, such as ion exchange or molecular sieving. The encapsulation in a polymeric hydrogel offers a unique balance between flexibility, ease of processing, and functionality, especially when the zeolite must remain in close contact with the hydrogel for effective performance in targeted applications like adsorption or controlled release.

Beyond encapsulating the ammonium-exchange zeolite within the polymeric hydrogel, several other methods of organizing the zeolite in relation to the hydrogel are possible, as long as the zeolite remains attached to the hydrogel matrix. In some embodiments, the zeolite particles are in a uniform layer on the surface of the polymeric hydrogel, allowing for easier interaction with the surrounding environment while maintaining structural integrity. Another embodiment involves embedding the zeolite within the hydrogel at discrete, defined points or forming localized regions within the material, facilitating targeted ion exchange without full encapsulation. Another embodiment involves attaching zeolite particles using a crosslinking agent or chemical bonding method to the polymer chains, creating a hybrid material that retains the functional properties of both the zeolite and polymeric hydrogel.

The composite material herein, formed by attaching zeolite to a polymeric hydrogel can be shaped in a range of geometries tailored to specific applications. These shapes can include spherical, cylindrical, and ring-shaped configurations, each offering distinct advantages in surface area exposure and mechanical stability. Alternatively, more complex geometries like hexagonal, star, or disc-shaped forms can be used to enhance interaction with surrounding environments or optimize ion exchange efficiency. Shapes such as spiral, helical, tetrahedral, octahedral, pyramidal, and prismatic structures provide additional options for optimizing packing density, flow dynamics, and surface area for targeted ion exchange processes. In some specific embodiments, the composite has a spherical shape. In other embodiments, the composite has a disc shape.

In some embodiments, the zeolite used in the disclosed processes has a particle size from about 10 μm to about 2500 μm, including, but not limited to, from about 100 μm to about 2000 μm, from 100 μm to about 1000 μm, from 100 μm to about 500 μm, from about 500 μm to about 2000 μm, and from about 500 μm to about 1000 μm. In some embodiments, chabazite is used in the disclosed processes, which has a particle size of about 10 μm, about 50 μm, about 100 am, about 200 μm, about 300 μm, about 400 μm, about 500 μm, about 600 μm, about 700 μm, about 800 μm, about 900 μm, about 1000 μm, about 1100 μm, about 1200 μm, about 1300 μm, about 1400 μm, about 1500 μm, about 1600 μm, about 1700 μm, about 1800 μm, about 1900 μm, about 2000 μm, about 2100 μm, about 2200 μm, about 2300 μm, about 2400 μm, about 2500 μm, or any combination of the foregoing values, including any range comprising the foregoing values.

In some embodiments, the zeolite used in the disclosed processes is a chabazite having a particle size from about 10 μm to about 2500 μm. For example, the chabazite used in the disclosed processes can have a particle size from about 100 μm to about 500 μm, or from about 500 μm to about 1000 μm. In some embodiments, the chabazite used in the disclosed processes has a particle size of about 10 μm, about 50 μm, about 100 μm, about 200 μm, about 300 μm, about 400 μm, about 500 μm, about 600 μm, about 700 μm, about 800 μm, about 900 μm, about 1000 μm, about 1100 μm, about 1200 μm, about 1300 μm, about 1400 μm, about 1500 μm, about 1600 μm, about 1700 μm, about 1800 μm, about 1900 μm, about 2000 μm, about 2100 μm, about 2200 μm, about 2300 μm, about 2400 μm, about 2500 μm, or any combination of the foregoing values, including any range comprising the foregoing values.

In some embodiments, the zeolite used in the disclosed processes has an average pore diameter from about 1 Å to about 10 Å. In a further aspect, the zeolite used in the disclosed processes has a particle size from about 1 Å to about 5 Å. In a still further aspect, the zeolite used in the disclosed processes has a particle size from about 5 Å to about 10 Å. In a yet further aspect, the zeolite used in the disclosed processes has a particle size of about 1.0 Å, about 1.1 Å, about 1.2 Å, about 1.3 Å, about 1.4 Å, about 1.5 Å, about 1.6 Å, about 1.7 Å, about 1.8 Å, about 1.9 Å, about 2.0 Å, about 2.1 Å, about 2.2 Å, about 2.3 Å, about 2.4 Å, about 2.5 Å, about 2.6 Å, about 2.7 Å, about 2.8 Å, about 2.9 Å, about 3.0 Å, about 3.1 Å, about 3.2 Å, about 3.3 Å, about 3.4 Å, about 3.5 Å, about 3.6 Å, about 3.7 Å, about 3.8 Å, about 3.9 Å, about 4.0 Å, about 4.1 Å, about 4.2 Å, about 4.3 Å, about 4.4 Å, about 4.5 Å, about 4.6 Å, about 4.7 Å, about 4.8 Å, about 4.9 Å, about 5.0 Å, about 6.1 Å, about 6.2 Å, about 6.3 Å, about 6.4 Å, about 6.5 Å, about 6.6 Å, about 6.7 Å, about 6.8 Å, about 6.9 Å, about 7.0 Å, about 7.1 Å, about 7.2 Å, about 7.3 Å, about 7.4 Å, about 7.5 Å, about 7.6 Å, about 7.7 Å, about 7.8 Å, about 7.9 Å, about 8.0 Å, about 8.1 Å, about 8.2 Å, about 8.3 Å, about 8.4 Å, about 8.5 Å, about 8.6 Å, about 8.7 Å, about 8.8 Å, about 8.9 Å, about 9.0 Å, about 9.1 Å, about 9.2 Å, about 9.3 Å, about 9.4 Å, about 9.5 Å, about 9.6 Å, about 9.7 Å, about 9.8 Å, about 9.9 Å, about 10.0 Å, or any combination of the foregoing values, including any range comprising the foregoing values.

In some embodiments, the zeolite used in the disclosed processes is a chabazite having an average pore diameter from about 1 Å to about 10 Å. In a further aspect, the chabazite used in the disclosed processes has a particle size from about 1 Å to about 5 Å. In a still further aspect, the chabazite used in the disclosed processes has a particle size from about 2 Å to about 5 Å. In a yet further aspect, the chabazite used in the disclosed processes has a particle size of about 1.0 Å, about 1.1 Å, about 1.2 Å, about 1.3 Å, about 1.4 Å, about 1.5 Å, about 1.6 Å, about 1.7 Å, about 1.8 Å, about 1.9 Å, about 2.0 Å, about 2.1 Å, about 2.2 Å, about 2.3 Å, about 2.4 Å, about 2.5 Å, about 2.6 Å, about 2.7 Å, about 2.8 Å, about 2.9 Å, about 3.0 Å, about 3.1 Å, about 3.2 Å, about 3.3 Å, about 3.4 Å, about 3.5 Å, about 3.6 Å, about 3.7 Å, about 3.8 Å, about 3.9 Å, about 4.0 Å, about 4.1 Å, about 4.2 Å, about 4.3 Å, about 4.4 Å, about 4.5 Å, about 4.6 Å, about 4.7 Å, about 4.8 Å, about 4.9 Å, about 5.0 Å, about 6.1 Å, about 6.2 Å, about 6.3 Å, about 6.4 Å, about 6.5 Å, about 6.6 Å, about 6.7 Å, about 6.8 Å, about 6.9 Å, about 7.0 Å, about 7.1 Å, about 7.2 Å, about 7.3 Å, about 7.4 Å, about 7.5 Å, about 7.6 Å, about 7.7 Å, about 7.8 Å, about 7.9 Å, about 8.0 Å, about 8.1 Å, about 8.2 Å, about 8.3 Å, about 8.4 Å, about 8.5 Å, about 8.6 Å, about 8.7 Å, about 8.8 Å, about 8.9 Å, about 9.0 Å, about 9.1 Å, about 9.2 Å, about 9.3 Å, about 9.4 Å, about 9.5 Å, about 9.6 Å, about 9.7 Å, about 9.8 Å, about 9.9 Å, about 10.0 Å, or any combination of the foregoing values, including any range comprising the foregoing values.

In some embodiments, the zeolite used in the disclosed processes has an ion exchange capacity of from about 0.5 meq/g to about 5 meq/g. In a further aspect, the zeolite has an ion exchange capacity of about 0.5 meq/g, about 0.6 meq/g, about 0.7 meq/g, about 0.8 meq/g, about 0.9 meq/g, about 1.0 meq/g, about 1.1 meq/g, about 1.2 meq/g, about 1.3 meq/g, about 1.4 meq/g, about 1.5 meq/g, about 1.6 meq/g, about 1.7 meq/g, about 1.8 meq/g, about 1.9 meq/g, about 2.0 meq/g, about 2.1 meq/g, about 2.2 meq/g, about 2.3 meq/g, about 2.4 meq/g, about 2.5 meq/g, about 2.6 meq/g, about 2.7 meq/g, about 2.8 meq/g, about 2.9 meq/g, about 3.0 meq/g, about 3.1 meq/g, about 3.2 meq/g, about 3.3 meq/g, about 3.4 meq/g, about 3.5 meq/g, about 3.6 meq/g, about 3.7 meq/g, about 3.8 meq/g, about 3.9 meq/g, about 4.0 meq/g, about 4.1 meq/g, about 4.2 meq/g, about 4.3 meq/g, about 4.4 meq/g, about 4.5 meq/g, about 4.6 meq/g, about 4.7 meq/g, about 4.8 meq/g, about 4.9 meq/g, about 5.0 meq/g, or any combination of the foregoing values, including any range comprising the foregoing values.

In some embodiments, the zeolite can be mesoporous zeolite. The alkali metal or alkaline earth metal ion contained in the zeolite can include lithium (Li) ion, sodium (Na) ion, potassium (K) ion, magnesium (Mg) ion, calcium (Ca) ion, barium (Ba) ion, or combination thereof.

In some embodiments, the chabazite can be mesoporous chabazite. The alkali metal or alkaline earth metal ion contained in the chabazite can include lithium (Li) ion, sodium (Na) ion, potassium (K) ion, magnesium (Mg) ion, calcium (Ca) ion, barium (Ba) ion, or combination thereof.

In various embodiments, the chabazite can be a zeolite that is prepared by treating a zeolite having a structure other than the chabazite structure with a strong base to be transformed into a zeolite having a chabazite structure. Examples of the zeolite having a structure other than the chabazite structure include, but are not limited to, a zeolite having a CC structure or an FCC structure. In some embodiments, the zeolite is faujasite.

The surface area to volume ratio of a hydrogel is crucial in determining its performance in various applications. In systems where zeolite or other materials are incorporated, a larger surface area enables more active sites for ion exchange, improving overall functionality. In some embodiments, the polymeric hydrogel in the present disclosure has a hydrogel surface area to volume ratio within about 2.5 to 5.0 cm²/cm³. In some embodiments, the polymeric hydrogel has a hydrogel surface area to volume ratio within about 3.0 to 4.0. The surface area to volume ratio within may be about 2.5 cm²/cm³, about 2.6 cm²/cm³, about 2.7 cm²/cm³, about 2.8 cm²/cm³, about 2.9 cm²/cm³, about 3.0 cm²/cm³, about 3.1 cm²/cm³, about 3.2 cm²/cm³, about 3.4 cm²/cm³, about 3.5 cm²/cm³, about 3.6 cm²/cm³, about 3.7 cm²/cm³, about 3.8 cm²/cm³, about 3.9 cm²/cm³, about 4.0 cm²/cm³, about 4.1 cm²/cm³, about 4.2 cm²/cm³, about 4.3 cm²/cm³, about 4.4 cm²/cm³, about 4.5 cm²/cm³, about 4.6 cm²/cm³, about 4.7 cm²/cm³, about 4.8 cm²/cm³, about 4.9 cm²/cm³, and about 5.0 cm²/cm³, or any combination of the foregoing values, including any range comprising the foregoing values.

In some embodiments, an ammonium oxidizing biofilm is attached to the polymeric hydrogel of the composite. The ammonium oxidizing biofilm (e.g., a biofilm comprising nitrifying and/or anammox bacteria) can be directly attached to the hydrogel surface, where it can benefit from the high surface area and structural stability provided by the hydrogel. The zeolite, incorporated either within or on the hydrogel matrix, serves to adsorb ammonium ions, creating a localized concentration gradient that facilitates efficient microbial activity. As ammonium is exchanged into the zeolite, the bacteria in the biofilm can oxidize it to nitrite, nitrate or nitrogen gas, further improving the overall nitrogen removal process. This integration of biological and material-based processes allows for a synergistic effect, where the zeolite provides rapid ion exchange and the biofilm enhances long-term ammonium removal through biochemical oxidation. In some embodiments, the ammonium oxidizing biofilm comprises ammonium-oxidizing microorganisms (AOM), anaerobic ammonium oxidizing (anammox) bacteria, or a combination thereof. In some embodiments, at least a portion of the ammonium oxidizing biofilm is attached to the ammonium exchange zeolite. In other embodiments, at least a portion of the ammonium oxidizing biofilm surrounds the zeolite and polymeric hydrogel. In further embodiments, the polymeric hydrogel and zeolite are coated with the ammonium oxidizing biofilm. In still further embodiments, the polymeric hydrogel and zeolite are one layer while the ammonium oxidizing biofilm is another layer wherein the two layers are attached.

In some embodiments, these ammonium-oxidizing microorganisms can include ammonia-oxidizing bacteria (AOB), ammonia-oxidizing archaea (AOA), or a combination of both. Ammonia-oxidizing bacteria are commonly found in environments with higher oxygen concentrations and are typically more abundant in soil and aquatic ecosystems. They use oxygen to oxidize ammonium to nitrite, a critical first step in the nitrification process. On the other hand, ammonia-oxidizing archaea, which are found in more extreme environments such as deeper marine waters or wastewater systems with lower oxygen levels, can also perform this oxidation. AOA are often more metabolically efficient under low-oxygen or more extreme conditions. In addition to AOB and AOA, other types of bacteria could also aid in the ammonium oxidation process. For example, nitrite-oxidizing bacteria (NOB) could complement the AOM by further converting the nitrite produced by AOB or AOA into nitrate. In some embodiments, the AOMs include Nitrosomonas europaea, Nitrosospira spp, Nitrosomonas eutropha, Nitrosovibrio spp, Candidatus Nitrosopumilus maritimus, Candidatus Nitrososphaera gargensis, Candidatus Nitrosotalea devanaterra, or a combination thereof.

In some embodiments, anaerobic ammonium oxidation (anammox) bacteria play a crucial role in nitrogen removal in environments with limited or no oxygen. These bacteria perform a unique process where ammonium and nitrite are converted directly into nitrogen gas (N₂) under anaerobic conditions, bypassing the traditional nitrification pathway. In the composites described herein, anammox bacteria could exist in anaerobic zones within the biofilm, where they would efficiently reduce nitrogen levels by converting ammonium and nitrite. In some embodiments, the anaerobic ammonium oxidation (anammox) bacteria comprises Brocadia anammoxidans, Kuenenia stuttgartiensis, Anammoxoglobus propionicus, Scalindua spp, Candidatus Brocadia spp, Candidatus Kuenenia spp, Jettenia spp, Kuenenia spp. or a combination thereof.

### Reactors and Systems

The present disclosure also provides a reactor for removing ammonium ions from wastewater, comprising the composites as described herein. For example, the reactor can comprise a composite that includes a PVA-SA hydrogel, with both an ammonium exchange zeolite and an ammonium oxidizing biofilm attached to the hydrogel.

In another aspect, the present disclosure provides a reactor for removing ammonium ions from wastewater. The reactor can comprise a polymeric hydrogel carrier; an ammonium exchange zeolite attached to the polymeric hydrogel carrier; and an ammonium oxidizing biofilm attached to the polymeric hydrogel carrier. In some embodiments, the polymeric hydrogel carrier comprises (PVA), polyethylene glycol (PEG), alginate, sodium alginate (SA), polyacrylamide (PAM), chitosan, gelatin, carrageenan, polyurethane, poly(lactic acid), poly(N-isopropylacrylamide) (PNIPAAm), carrageenan, hyaluronic acid, polyacrylic acid (PAA), and polyvinylpyrrolidone (PVP), or a combination thereof. In further embodiments, the polymeric hydrogel comprises polyvinyl alcohol. In some embodiments, the polymeric hydrogel further comprises sodium alginate.

In some embodiments, the polymeric hydrogel carrier has a shape that is spherical, cylindrical, ring-shaped, hexagonal, star, disc-shaped, spiral, helical, tetrahedral, octahedral, pyramidal, or prismatic. In some embodiments, the polymeric hydrogel carrier has a spherical shape. In some embodiments, the polymeric hydrogel carrier has a disc shape.

In some embodiments, the polymeric hydrogel carrier has a hydrogel surface area to volume ratio within a range of 2.5 to 5.0. cm²/cm³. In some embodiments, the polymeric hydrogel carrier has a hydrogel surface area to volume ratio within a range of 3.0 to 4.0 cm²/cm³.

In some embodiments, the zeolite has an average particle size between 10 and 1000 μm. For example, the zeolite can have an average particle size between 100 and 500 μm.

In some embodiments, at least a portion of the ammonium oxidizing biofilm is attached to the ammonium exchange zeolite. In some embodiments, at least a portion of the ammonium oxidizing biofilm surrounds the zeolite and polymeric hydrogel carrier. In some embodiments, the polymeric hydrogel carrier and zeolite are coated with the ammonium oxidizing biofilm. In some embodiments, the polymeric hydrogel carrier and zeolite are one layer while the ammonium oxidizing biofilm is another layer wherein the two layers are attached.

In some embodiments, the reactor further comprises a container, wherein the polymer carrier having the ammonium exchange zeolite and the ammonium oxidizing biofilm attached thereto is placed inside the container, and wherein the container is configured to introduce wastewater to contact the ammonium exchange zeolite and the ammonium oxidizing biofilm.

In some embodiments, the reactor is selected from a moving bed biofilm reactor (MBBR), membrane bioreactor (MBR), anaerobic baffled reactor, sequencing batch biofilm reactor (SBBR), fluidized bed reactor, or an integrated fixed film activated sludge (IFAS) reactor.

The present disclosure also provides a wastewater treatment system comprising the reactors as described herein. For example, the system can include a reactor having the composite material as described herein, or the system can include a reactor having a polymeric hydrogel carrier as described herein. The composite or reactor can be in the form of a disposable unit, such as a cartridge, a disc, or a replacement package, that is installed into the system before use.

In some embodiments, the system further comprises a control unit for introducing wastewater into the reactor, monitoring the removal of ammonium ions from the wastewater, and/or discharging wastewater after treatment. The control unit can include a computer, software, and user instruction for operation. The control unit can acquire, store, and process data from the wastewater treatment process. Such data may include, but are not limited to, temperature, air quality, biomass growth, organic substance level, zeolite regeneration (e.g., as measured by ammonium ion absorption efficiency), and concentrations of various ions in the wastewater. The control unit can include analytical tools or software to analyze the data, such as plotting, comparing, or exporting the data on a user interface. The control unit can also include indicators showing the status of system operation (e.g., on/off or empty/full) and requirement for user intervention (e.g., replacement of the composite material or reactor).

The present system may include one or more other components, such as devices or equipment for aerating the reactor, pumps or mixers for increasing circulation, a basin or housing, and/or filters for clarifying the effluent. Other suitable components used in known water treatment technologies can also be included. These components can be controlled by, or transmit data to, the control unit. In some embodiments, the present system is automated with a programmed operating sequence.

### Methods

In another aspect, the present disclosure provides a method of treating wastewater comprising ammonium ions. The method comprises contacting the wastewater with the composites material as described herein for a treatment duration, thereby concentration of the ammonium ions in the wastewater is reduced.

In another aspect, the present disclosure provides another method of treating wastewater comprising ammonium ions. The method comprises introducing the wastewater into the reactor as described herein for a treatment duration, such that the wastewater contacts the ammonium exchange zeolite and the ammonium oxidizing biofilm attached to the polymer carrier, thereby concentration of the ammonium ions in the wastewater is reduced.

The treatment duration can be, for example, one or more days. In some embodiments, the duration is about 1 day to about 10 days, such as about 2 days, about 3 days, about 4 days, about 5 days, about 6 days, about 7 days, or about 8 days. In some embodiments, the treatment duration incudes several cycles. At the end of each cycle, the zeolite in the composite material or reactor can be regenerated (e.g., via biological oxidation of the absorbed ammonium ions). In a multi-cycle treatment, the duration can be the total treatments days of each cycle combines. As a nonlimiting example, for a 4-cycle treatment with each cycle being about 5-8 days, the treatment duration can be about 20 days to about 32 days.

In some embodiments of the method for treating wastewater, the ammonium ions are absorbed by the ammonium exchange zeolite, which is then regenerated by the ammonium oxidizing biofilm via biological oxidation of the absorbed ammonium ions. In further embodiments, the wastewater comprises ground water, lake water, river water, municipal wastewater, industrial wastewater, landfill leachate, or a combination thereof.

In some embodiments, the treated wastewater can be recirculated through the hydrogel-zeolite composite system to enhance the removal of ammonium ions. By continuously passing the wastewater through the system, ammonium ions are adsorbed by the zeolite and later regenerated through biological oxidation by the ammonium oxidizing biofilm, ensuring a sustainable and ongoing purification process.

In some embodiments, the wastewater can be processed as mainstream or sidestream depending on the treatment configuration. In mainstream treatment, the wastewater is treated directly as it enters the system, typically from municipal or industrial sources, ensuring immediate and continuous purification. Alternatively, in sidestream treatment, the wastewater is diverted from the main flow after primary treatment, allowing for targeted and more concentrated removal of ammonium ions in specific sections of the treatment process.

In some embodiments, mainstream water can be introduced into system at a controlled rate between 15 and 50 mL/min. This flow rate ensures optimal contact between the wastewater and the composite material, allowing for efficient adsorption of ammonium ions by the zeolite while maintaining adequate conditions for biological oxidation by the ammonium oxidizing biofilm. The controlled introduction of water helps balance the system's ion exchange capacity and microbial activity, maximizing the effectiveness of the treatment process. In further embodiments, mainstream water can be introduced into system at a controlled rate between 20 and 35 mL/min.

In mainstream wastewater, ammonium concentrations typically range from 20 to 150 mg/L, depending on the source and the specific characteristics of the wastewater. Municipal wastewater often falls within the lower end of this range, around 20 to 50 mg/L, while industrial or heavily contaminated effluents can have higher ammonium levels, reaching up to 2000 mg/L or more. This variability highlights the need for adaptable treatment systems capable of efficiently removing ammonium across different concentration ranges. In some embodiments, the ammonium concentration of the mainstream water tested is above 100 mg/L. In further embodiments, the ammonium concentration of the mainstream water tested is about 120 mg/L.

In another aspect, the present disclosure further provides a method of preparing a composite, which comprises a polymeric hydrogel and an ammonium exchange zeolite attached to the polymeric hydrogel, wherein the polymeric hydrogel comprises polyvinyl alcohol (PVA) and a second polymer component. The method comprises: mixing the polyvinyl alcohol, the second polymer component, and the ammonium exchange zeolite in water to form a mixture; and adding a crosslinking solution to the mixture, thereby forming the composite. As a nonlimiting example, the method can comprise mixing the polyvinyl alcohol and the second polymer component with deionized water to form a first mixture. The method can further comprise heating the first mixture, e.g., until no undissolved granules are present. The method can further comprise adding the ammonium exchange zeolite to the heated first mixture to form a second mixture. The method can further comprise adding the crosslinking solution to the second mixture, thereby forming the composite. The preparation method as described herein can further comprise isolating the composite.

In some embodiments, the weight ratio of polyvinyl alcohol and the second polymer component is between 5:1 and 1:5, such as about 4.5:1, about 4:1, about 3:1, about 2;1, about 1:1, about 1:2, about 1:3, about 1:4, or about 1:4.5. In further embodiments, the weight ratio of polyvinyl alcohol and the second polymer component is about 1:1. In some embodiments, the crosslinking solution includes barium chloride, calcium chloride, sodium tripolyphosphate, glutaraldehyde, citric acid, potassium carbonate, or combinations thereof. In some embodiments, the crosslinking solution comprises barium chloride, which is used to facilitate the formation of a stable network in the hydrogel matrix. When combined with the polymeric hydrogel, barium chloride can initiate crosslinking reactions that help to integrate and stabilize the zeolite particles within the hydrogel structure, ensuring their attachment and uniform distribution.

The present disclosure further provides a composite prepared by the methods described herein. For example, the composite material produced by the present preparation method can include a PVA-SA hydrogel and chabazite attached to the hydrogel.

From the foregoing, it will be seen that embodiments herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and sub-combinations are of utility and may be employed without reference to other features and sub-combinations. This is contemplated by and is within the scope of the claims.

Since many possible embodiments may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only and is not intended to be limiting. The skilled artisan will recognize many variants and adaptations of the embodiments described herein. These variants and adaptations are intended to be included in the teachings of this disclosure and to be encompassed by the claims herein.

Now having described the embodiments of the present disclosure, in general, the following Examples describe some additional embodiments of the present disclosure. While embodiments of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

### Example 1

The present disclosure demonstrates fabrication of a biofilm carrier that incorporated chabazite and promoted biofilm growth to achieve a faster ammonium removal rate than raw chabazite. Hydrogels were used in the past for bacteria immobilization and as carriers for wastewater treatment due to their swelling property, non-toxicity to the microorganisms as well as their porous nature. These properties allowed the organisms to be successfully immobilized reducing clogging within the system while still allowing diffusion of the wastewater to these organisms.

In this work, polyvinyl alcohol-sodium alginate (PVA-SA) hydrogel carriers with encapsulated chabazite were synthesized and implemented for the removal of ammonium in wastewater treatment plants. The reduction in particle size of the chabazite was also investigated and the results showed a higher ammonium removal rate when the smaller particle size was used. The smaller particle size also allowed for more homogenous distribution within the carrier.

The present disclosure also investigates changes in carrier performance when changing the geometry of the hydrogel carriers from disks to spheres and how the abiotic performance was affected. The results showed no significant differences even with smaller spheres due to the similar surface area to volume ratio.

In some experiments, kinetic and isotherm modelling of the PVA-SA hydrogel disk carriers were done, showing a best fit to the pseudo second order kinetic model with an R² value of 0.978. The Freundlich isotherm model best fit the equilibrium isotherm data with a R² value of 0.987.

Batch tests were done showing the effective removal of ammonium using these carriers with ammonium oxidizing microorganisms (AOM). This coupled approach of combining ion exchange with the bioregeneration by AOM has not been researched previously using chabazite and it was observed that this approach helps to promote ammonium removal as the batch test using the carrier with encapsulated chabazite and AOM on the outside of the carrier achieved the fastest ammonium removal rate (3 days) compared to the batch test using AOM and chabazite without a carrier (5 days). Both tests reduced the ammonium concentration in 8 days in the first cycle. This test was repeated with a batch test using the carrier with encapsulated chabazite and AOM but showed no bioregeneration due to the microbes possibly dying when placed in deionized water. The test was repeated at a smaller scale and showed bioregeneration of the zeolite based on the nitrite production. The small-scale test achieved a reduced cycle time from 8 days in the 1st cycle to 5 days in the 2nd cycle.

In various experiments, the present disclosure demonstrates combination of ion exchange material (e.g., chabazite) with carriers and AOM to remove ammonium in wastewater. In particular examples, biofilm carriers were fabricated with embedded chabazite. It is hypothesized that the chabazite would create concentrated ammonium areas on the carrier that would be conducive to the microbes, helping them to promote microbial activity, develop biofilms and increase the growth of biomass which would then lead to faster removal of the ammonium ions. The microbes may also bioregenerate the chabazite faster than in traditional ion exchange systems with microbes that did not use carriers (e.g., zeolite and microbes only) due to the higher surface area on the carrier allowing for better microbial adhesion. Specific experiments were conducted to: (1) fabricate and optimize carriers with encapsulated zeolite, such as chabazite, including development of the carrier with desirable zeolite encapsulation repeatable performance; (2) evaluate the ammonium removal due to the ion exchange process of the synthesized carrier; and (3) evaluate the bioregeneration of the synthesized carrier using AOM and its impact on the ammonium removal performance.

### Materials

Chabazite, wastewater and groundwater were used for experiments in this work. The chabazite used was obtained from the St. Cloud Zeolite Company located in Winston, New Mexico. The groundwater was obtained from the Botanical Garden at the University of South Florida Tampa, Florida. The wastewater used in this work was collected from the Hillsborough County Northwest Regional Water Reclamation Facility in Tampa, Florida.

The PVA-SA hydrogel carriers were made using Polyvinyl Alcohol obtained from Sigma Aldrich, Sodium alginate made from brown algae, obtained from Sigma Aldrich, chabazite and a 4 wt. % barium chloride crosslinking solution in deionized water was made using anhydrous barium chloride obtained from Fisher Scientific. A disk silicone mold obtained from Baker Depot with each of the disk cavities measuring 4 cm in diameter and 2 cm in depth were used to make the disk hydrogels and a spherical silicone mold obtained from IC ICLOVER with each cavity measuring 0.9 cm in diameter was used to make the spherical hydrogel carriers.

The isotherm, kinetic and ion exchange tests in this work were done using a synthetic wastewater solution. The synthetic wastewater solution was made using 40% wastewater, 60% groundwater and was filtered using microfiber filters from Fisher scientific with a particle retention of 1.5 μm to remove sediment. Ammonium bicarbonate obtained from Fisher Scientific was used to adjust the ammonium concentration.

The batch tests in this project were done using AOM that had been previously enriched for two years to ensure stability using activated sludge from the Northwest Regional Water Reclamation Facility in Tampa, Florida (Chero-Osorio, 2022). The batch tests used a feed solution with 1 L of groundwater containing ammonium bicarbonate to achieve the 120 mg/L ammonium concentration, sodium bicarbonate at 1.2 g/L, buffer solutions with dipotassium phosphate at 0.4 mL/L and monopotassium phosphate at 0.6. mL/L. The solution also contained trace element A with a composition of ethylenediaminetetraacetic acid (EDTA) and ferrous sulfate (FeSO₄) both at a 5 g/L concentration and obtained from Fisher Scientific and MP biomedicals respectively. The feed solution contained trace element B containing EDTA at 15 mg/L, zinc sulphate heptahydrate (ZnSO₄·7H₂O) at 0.430 mg/L, cobalt (II) chloride hexahydrate (CoCl₂·6H₂O) at 0.240 mg/L, manganese (II) chloride tetrahydrate (MnCl₂·4H₂O) at 0.990 mg/L, copper sulfate pentahydrate (CuSO₄·5H₂O) at 0.250 mg/L, sodium molybdate dihydrate (Na₂MoO₄·2H₂O) at 0.243 mg/L, nickel sulfate hexahydrate (NiSO₄·6H₂O at 0.302 mg/L, Boric acid (H₃BO₃) at 0.011 mg/L, and Sodium selenate (Na₂SeO₄) at 0.107 mg/L. This feed solution was made using the same formulation as the solution used for the AOM enrichment and mother reactor to reduce variability (Chero-Osorio, 2022).

### Chabazite Pretreatment

Chabazite was pretreated using a groundwater solution due to the reported higher ion exchange capacity after the pretreatment was done in previous work (Aponte-Morales, 2015; Chero-Osorio, 2022). This was due to the decreased sodium ions concentration after the treatment was completed reducing the sodium effect on the nitritation process when used in biological treatment (Aponte-Morales, 2015; Chero-Osorio, 2022).

The groundwater pretreatment was done using a procedure detailed in previous work (Aponte-Morales, 2015). The unmodified chabazite was first sieved to ensure that it was between 1-2 mm. The chabazite was washed with deionized water to remove any fine powders that might have remained. The chabazite was then dried at 100° C. for 24 hours. After the chabazite was dried, about 30 grams was placed in a 250 ml Erlenmeyer flask with 200 ml of local groundwater. The flasks were then placed on a VWR Advanced Digital Shaker at 200 RPM at room temperature (25° C.) for 3 hours. The chabazite was then decanted and rinsed with deionized water. The flasks with the washed chabazite were then dried for 24 hours at 100° C.

The unmodified chabazite was crushed using a mortar and pestle and was sieved using two sieves one with mesh at 425 μm and one with mesh at 105 μm to ensure a size between 0.4 mm to 0.1 mm instead of 1 mm to 2 mm. The crushed chabazite was pretreated with groundwater using the same procedure used for the unmodified chabazite. This was to ensure a uniform size and maintain the same conditions for both particle sizes.

### Disk Hydrogel Carriers

The disk hydrogels were made using an adapted procedure from previously published work (Landreau et al., 2020). A 1:1 w/w ratio of polyvinyl alcohol and sodium alginate (PVA-SA) was used to create a combined 13 wt. % concentration with deionized water. To create a single disk mold 0.5 grams of polyvinyl alcohol was added to a 50 mL beaker with 0.5 grams of sodium alginate and 7 grams of water. The beaker was then weighed and placed on a heating mantle for approximately 1 hour with continuous stirring at 120° C. creating a final concentration of 14 wt. % PVA-SA with deionized water. The solution was heated until there were no undissolved granules in present. After heating, the chabazite was added and mixed in the beaker. A crosslinking solution of 4 wt. % barium chloride solution (20 ml) was then slowly added to the beaker using a syringe. The syringe tip was placed near the wall of the beaker when adding the barium chloride solution to reduce the formation of dents in the carriers. The disk carriers were then covered with Parafilm® laboratory sealing film for 24 hours to complete the crosslinking process. The barium chloride solution was then decanted out of the beaker and deionized water was added to the beaker with the carrier for storage.

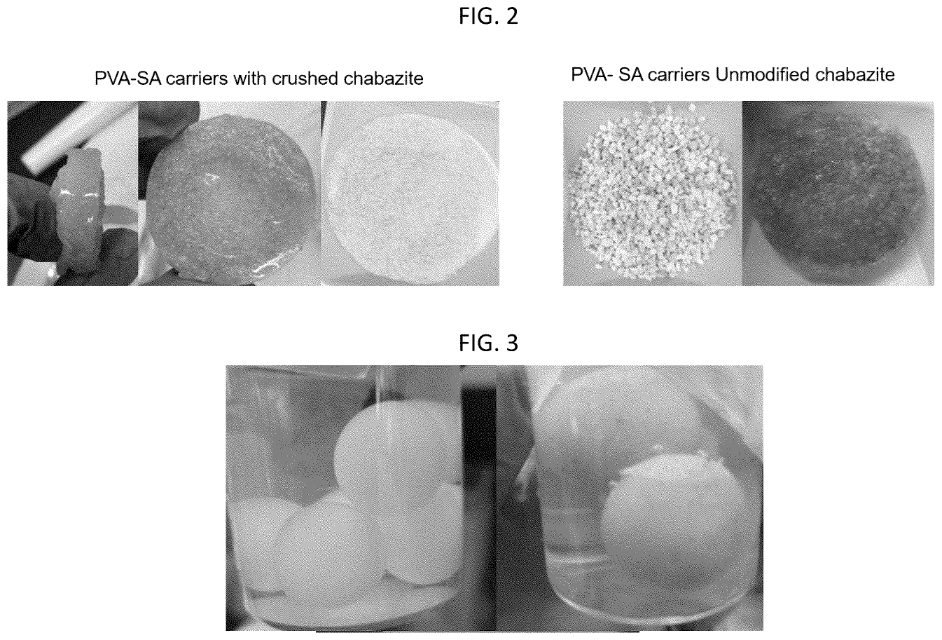

When making the disk carriers in batches, the same PVA-SA solution was scaled up and after heating, the chabazite was added but the solution was placed into a disk mold before adding the crosslinking solution. The disk mold was placed on a scale to ensure that each disk had the same amount of PVA-SA solution and chabazite. The barium chloride solution was then added to each disk mold for 24 hours. The disks were then removed from the mold and placed in a large beaker with deionized water. The disks were approximately 4 cm in diameter and 1 cm thick. As non-limiting examples, FIG. 2 shows the disk hydrogel carriers using chabazite at different particle sizes.

### Spherical Hydrogel Carriers

The spherical hydrogels were made using the same PVA-SA solution concentration as the disk hydrogels. However, after adding the chabazite, they were then added to a spherical mold and set to freeze at 0° C. for 3 hours to hold their shape. They were then removed from the spherical mold and placed in a beaker with 4 wt. % BaCl₂ solution to be crosslinked for 24 hours. The spheres were then removed and placed in deionized water. The spheres are about 1.8 cm in diameter and are shown in FIG. 3 using the crushed chabazite.

### Isotherm and Kinetic Studies

Kinetic studies were done using 1 gram of chabazite encapsulated inside the hydrogel disks. Ammonium bicarbonate was added to synthetic wastewater solution to achieve a final ammonium concentration (as nitrogen) of 100 mg/L. Each disk was placed inside a 250 Erlenmeyer flask with 200 mL of the synthetic wastewater solution. The flasks were then covered with parafilm and placed on a shaker table at 170 RPM. Samples (2 mL) were then taken at various times to determine the concentration at each time. The experiment was done for 24 hours.

Kinetic tests were also done with a similar setup using the spherical hydrogel carriers to compare the ammonium removal with the disk carriers. Since the spherical carriers were smaller, four sphere carriers were placed inside each flask compared to one of the disk carriers. Each sphere consisted of 1.5 g of the PVA-SA solution with 0.25 g of chabazite before being crosslinked with barium chloride. The disk carriers used in this kinetic test were made using 6 g of PVA-SA solution and 1 g of chabazite before being crosslinked.

The isotherm studies were done using crushed chabazite encapsulated inside the hydrogel disks. The amount of chabazite inside each hydrogel was kept constant at 1 g of chabazite. Each hydrogel carrier was placed inside a 250 ml Erlenmeyer flask with 200 ml of the synthetic wastewater solution. The initial concentration was varied for each flask (100, 200, 400, 600, 800, 1000) mg/L (NH4-N). The flasks were placed on the shaker table for 24 hours after which, 2 ml of sample was taken from each flask to measure the ammonium concentration.

Batch Tests with Carriers

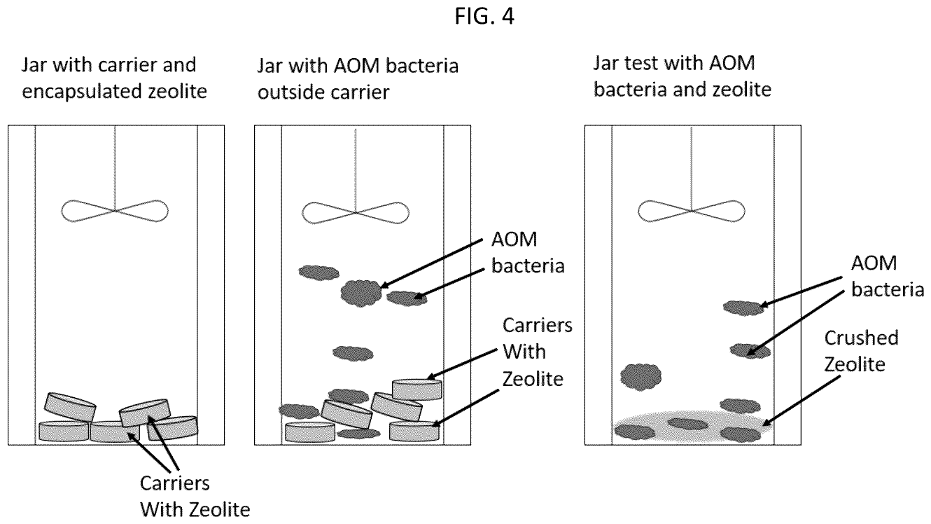

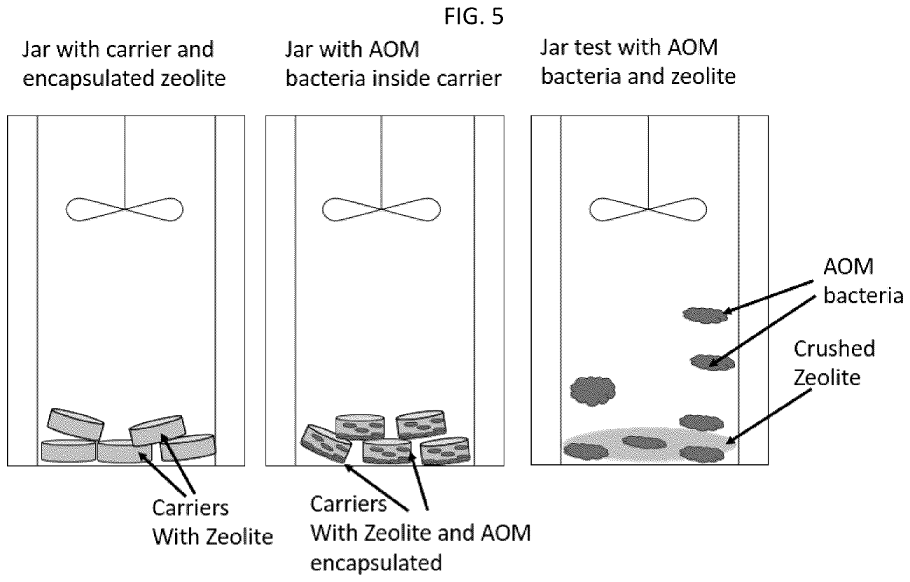

Batch tests were done to evaluate the bioregeneration of the disk carriers in a groundwater solution. The batch tests were done using the EC engineering compact laboratory mixer (jar tester) (serial no. 63108) manufactured in Alberta, Canada to maintain similar conditions for each of the tests done. The batch tests aimed to compare the ammonium removal in three conditions, when the AOM was on the outside of the hydrogel carrier with encapsulated chabazite (novelty), when the AOM was used with the chabazite only (Positive control) and finally, when an abiotic test was done where only the hydrogel carrier with encapsulated zeolite (negative control) was added to the groundwater solution. A schematic of this experiment is shown in FIG. 4.

The positive and negative controls in the batch test were also repeated with another condition to analyze the ammonium removal when the AOM was encapsulated inside the hydrogel disk with the zeolite instead of being outside the carrier. A schematic of this experiment is shown in FIG. 5. The experiment where the AOM was encapsulated inside the hydrogel disk was also done on a smaller scale using 200 ml of the groundwater feed solution, 1 g of the crushed zeolite and 0.69 mg of AOM biomass encapsulated in a single carrier. The carrier and groundwater solution were placed in a 250 mL Erlenmeyer flask and placed on a shaker table at 100 RPM. This experiment was done in duplicate and the ammonium, nitrite and nitrate concentrations were monitored daily.

In each jar test, the chabazite amount was kept constant at 5 g and in the jars containing the AOM, the biomass was kept constant at 3.47 mg for each jar. Each jar also contained 1 L of the ground water solution. Each hydrogel carrier was made using 1 g of crushed chabazite and 6 g of the PVA-SA solution so that five carriers were added to the jars except for the test that used only the crushed chabazite and AOM. The jars were sampled daily to monitor the concentrations of ammonium, nitrite, and nitrate. The dissolved oxygen (DO) in each jar were also monitored daily to ensure a DO of 2 mg/L. This was to ensure the suppression of NOB and ensure that the AOM had enough oxygen to survive. The pH was also checked to ensure it was conducive to the microbes' survival.

The AOM microbes which were previously enriched in a mother reactor for over two years with the same groundwater solution to ensure stable development of the microbes (Chero-Osorio, 2022). The same groundwater solution was used for the batch tests but at a lower ammonium concentration 120 mg/L (NH₄—N) instead of 400 mg/L (NH₄—N) as in the mother reactor.

### Analytical Methods

The ammonium, nitrite, nitrate, potassium, magnesium and sodium concentrations in this project were analyzed using the Ion Chromatography Metrohm 881 Compact IC Pro ion chromatograph (IC Application No. C-115 and No. S-236) made in Herisau, Switzerland using standard method 3500 (Rice et al., 2012). The pH was measured using the Orion 5 Star multifunction meter from Thermo Scientific made in Singapore using standard method 4500-H (Rice et al., 2012). The dissolved oxygen was measured using the Orion 5 Star multifunction meter from Thermo Scientific made in Singapore using standard method 4500-0 (Rice et al., 2012).

### Results and Discussion

### Isotherm and Kinetic Studies on Disk Hydrogel Carriers

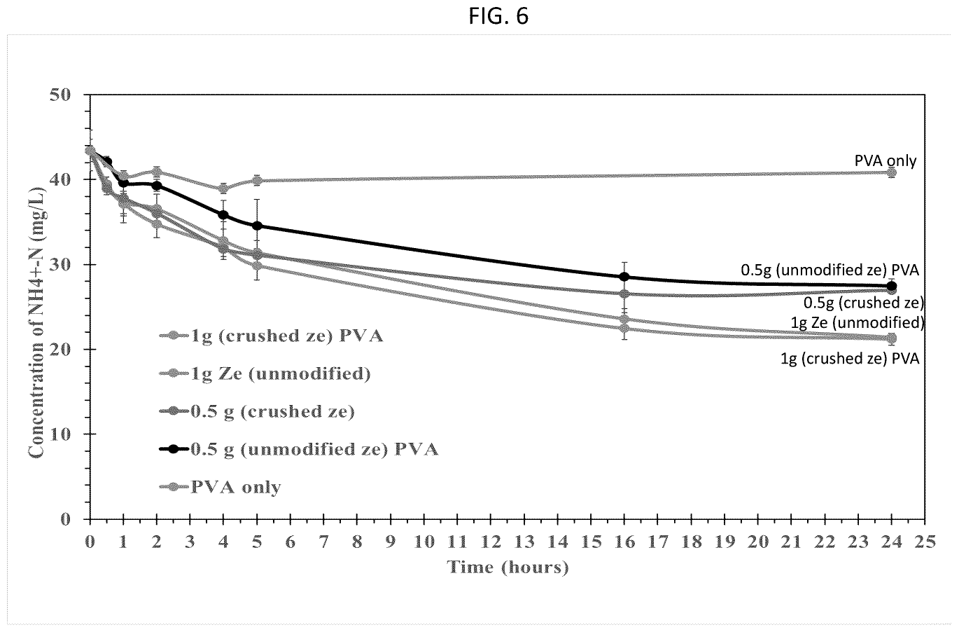

FIG. 6 shows the ammonium removal using the disk hydrogels in a kinetic study with varying amounts of crushed and unmodified chabazite. FIG. 6 shows that the larger unmodified chabazite had a slower rate of adsorption of the ammonium ions as compared to the smaller crushed chabazite particles. This can be attributed to the smaller chabazite particle size creating a higher surface area to volume ratio and allowing for better diffusion of ammonium into the particle. Another reason for using the crushed chabazite over the uncrushed chabazite is the more homogenous distribution of the crushed chabazite inside of the hydrogel. The unmodified chabazite settled to the bottom of the hydrogel carrier while being crosslinked, while the crushed chabazite would remain suspended inside the hydrogel due to the lower weight of the individual particles. This resulted in a more homogenous carrier. FIG. 6 also shows that regardless of the particle size, increasing the amount of chabazite (ze) increased the amount of ammonium adsorption with the carrier. This is due to the increased number of adsorption sites for the ammonium ions. A slight change in concentration was observed when using the PVA-SA hydrogel disk carriers without any chabazite. This is caused by the diffusion of deionized water from inside of the carrier to the synthetic wastewater solution and does not indicate any ammonium adsorption by the PVA-SA material.

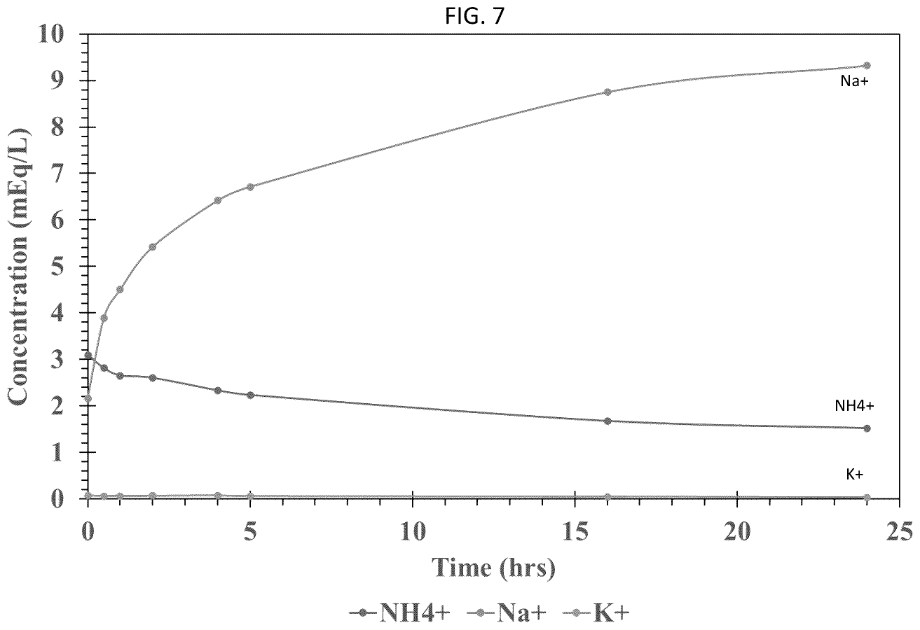

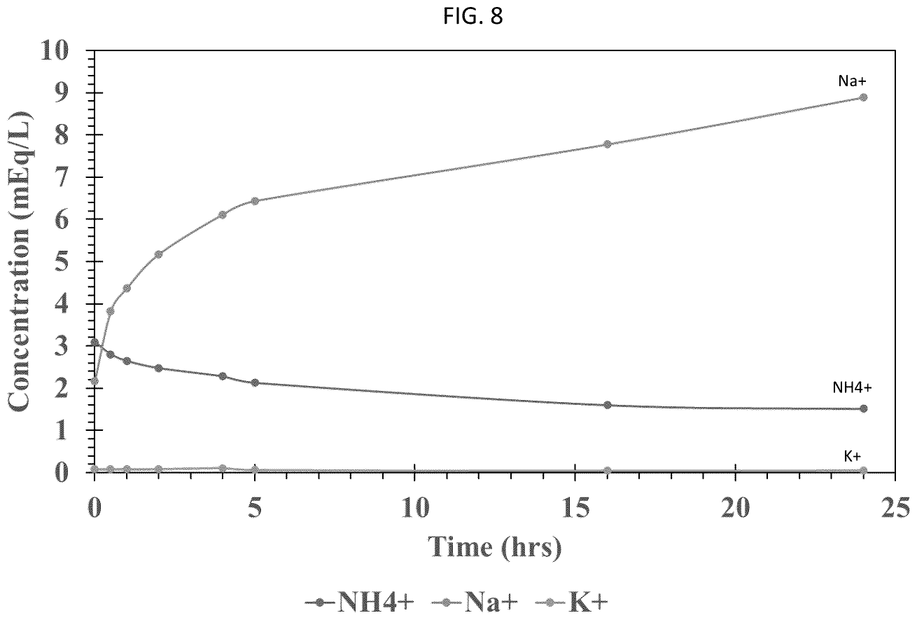

Concentrations of the NH₄⁺, Na⁺ and K⁺ ions calculated in milliequivalents are shown in FIG. 7 and FIG. 8. These figures show the ion exchange on the hydrogel disk carriers using unmodified and crushed chabazite, respectively. There was relatively no change in the potassium concentration throughout the experiment. The figures show that sodium is desorbed from the carriers over time while ammonium is adsorbed from the synthetic wastewater solution. The figures show that adsorption and desorption of the sodium and ammonium ions are relatively equal for the first 5 hours but after this point, there are more sodium ions being desorbed than ammonium ions adsorbed. This can be due to other competing ions present in the wastewater solution affecting the rate of adsorption of the ammonium ions. The ion exchange selectivity of chabazite is Tl⁺>Cs⁺>K⁺>Ag⁺>Rb⁺>NH₄⁺>Pb²⁺>Na⁺═Ba²⁺>Sr²⁺>Ca²⁺>Li⁺ (Chero-Osorio, 2022).

### Isotherm and Kinetic Modelling on Disk Hydrogels

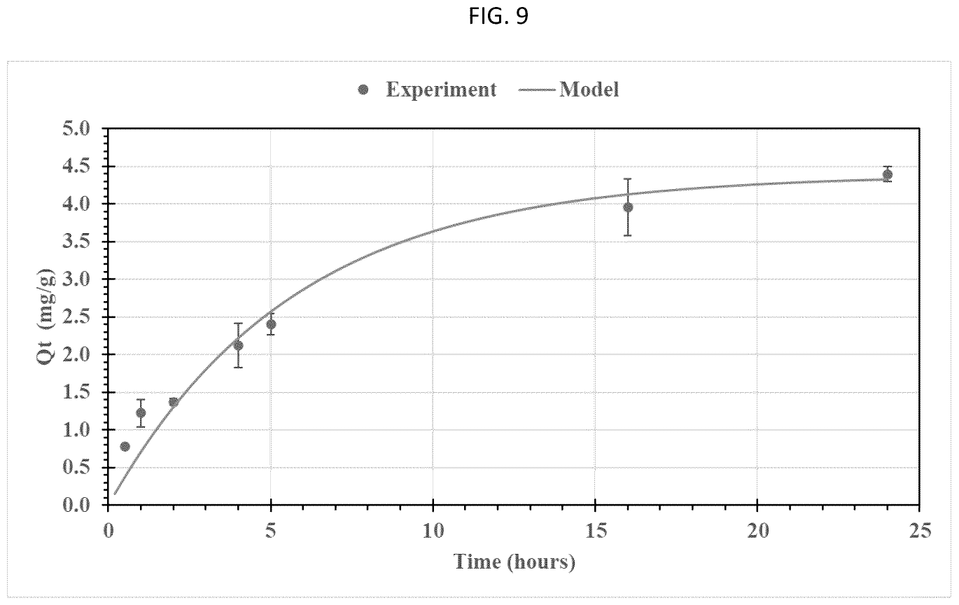

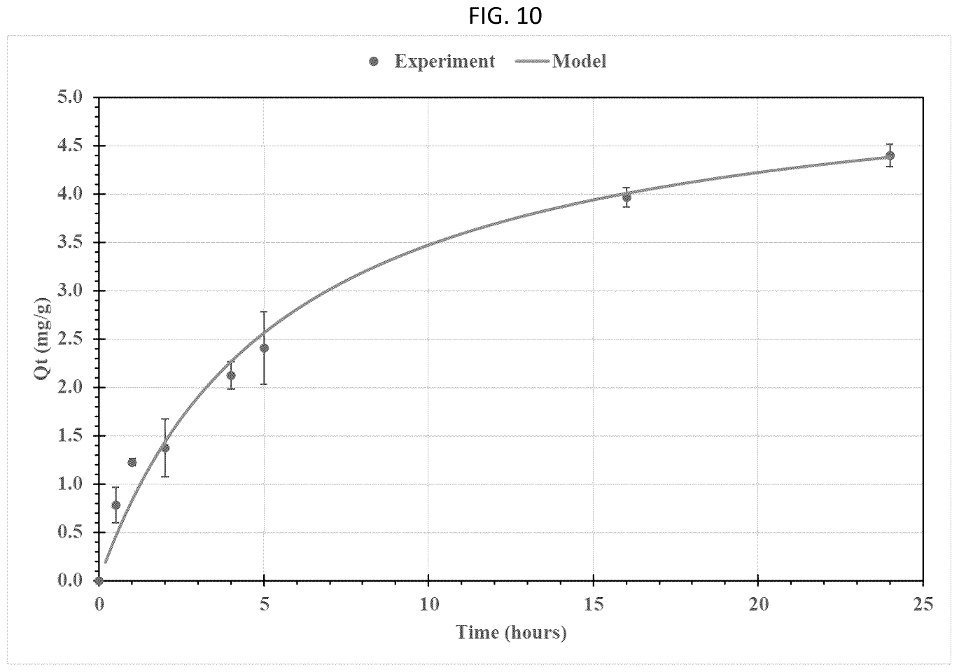

Results of the kinetic modelling of the disk hydrogel carriers with encapsulated chabazite using the pseudo first order kinetic model (PFO) (Equation 1) and pseudo second order (PSO) (Equation 2) kinetic models respectively are shown in FIG. 9 and FIG. 10. The R² value for the PFO model was 0.967 and the R² value for the PSO model was 0.978 indicating that the data fit better on the PSO model.

TABLE 2
Kinetic model parameters

| Kinetic | Equilibrium adsorption | | | |
|---|---|---|---|---|
| models | capacity (qₑ) | Rate constants | | R² |
| PFO | 4.40 (mg/g) | 0.176 | (1/hr) | 0.967 |
| PSO | 5.39 (mg/g) | 0.034 | (g/mg/hr) | 0.978 |

$${q}_{t} = {q}_{e} * ( 1 - {e}^{- {k}_{1} t} ) \qquad [ Equation 1 ( Agbovi \& Wilson , 2021 ) ]$$

$${q}_{t} = \frac{{k}_{2} * t * {q}_{e}^{2}}{1 + {k}_{2} * {q}_{e} * t} \qquad [ Equation 2 ( Agbovi \& Wilson , 2021 ) ]$$

The equations for the PFO and PSO models are given in Equations 1 and 2 respectively, where (t) is the time in hours (hrs), (qₜ) is the amount ammonium ions adsorbed at a specific time (mg/g), (qₑ) is the adsorption capacity at equilibrium (mg/g), (k₁) is the first order rate constant in (hr⁻¹), (k₂) is the second order rate constant in (g/mg/hr). The parameters found from both kinetic models are summarized in Table 2.

An adsorption isotherm experiment was done using the disk hydrogels with a constant amount of crushed chabazite over a 24-hour period, with varying concentrations of NH4⁺—N and the data were fit using the Langmuir and Freundlich models. The Langmuir model assumes homogenous monolayer adsorption, a constant number of sites and no interactions between the ions (Islam et al., 2021).

$${q}_{e} = {q}_{max} \frac{{K}_{L} * {C}_{{NH}_{4}^{+}}}{1 + {K}_{L} * {C}_{{NH}_{4}^{+}}} \qquad [ Equation 3 ( Islam et al . , 2021 ) ]$$

$${q}_{e} = {K}_{f} - {C}_{{NH}_{4}^{+}}^{1 / n} \qquad [ Equation 4 ( Islam et al . , 2021 ) ]$$

The Langmuir model is shown in Equation 3 where qₑ is the adsorption capacity at equilibrium (mg/g), qₘₐₓ represents the adsorption capacity (mg/g), K_{L} is the Langmuir isotherm equilibrium constant related to the affinity of the binding site (L/mg) and C_{NH}_{₄}₊ is the concentration of ammonium ions at equilibrium in mg/L. The Freundlich isotherm equation is given in Equation 4 where 1/n is the adsorption intensity and K_{f} is the Freundlich affinity constant. The Freundlich model is empirical based unlike the Langmuir and ion exchange model and is applicable to adsorption on heterogenous as well as homogenous surfaces (Qiu et al., 2012). These equations were solved in their nonlinear form to find the R² values.

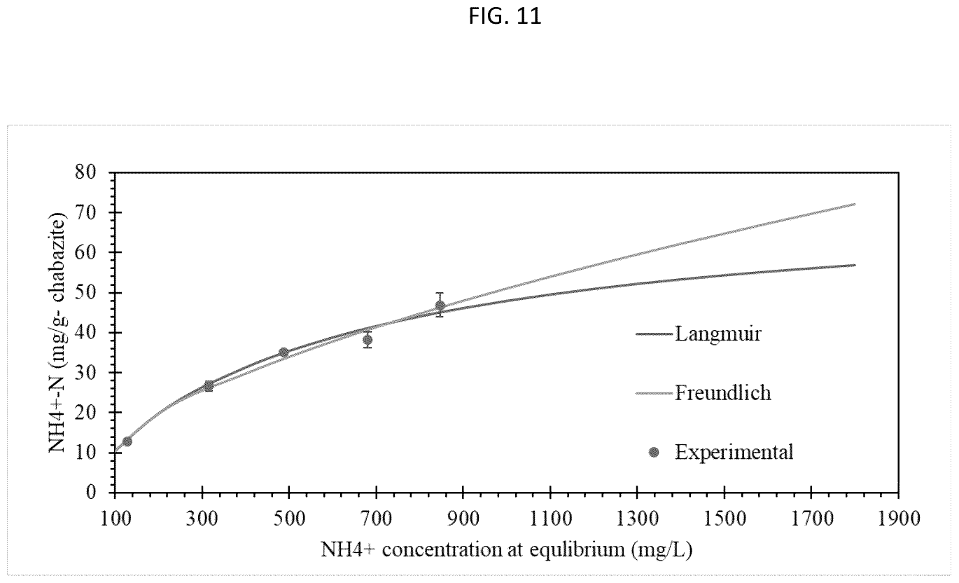

The isotherm models for the disk carriers using the Freundlich and Langmuir models are shown in FIG. 11. The R² values for each model were calculated with the best fit shown to be the Freundlich model with an R² value of 0.988. The Langmuir model also had a close fit with an R² value at 0.979. The model parameters are summarized in Table 3.

TABLE 3
Isotherm model parameters

| | | | Maximum adsorption | |
|---|---|---|---|---|
| Models | K constants | n | capacity | (R²) |
| Langmuir | 1.68E−06 (L/mg) | N/A | 77.1 (mg/g) | 0.979 |
| Freundlich | 8.55E−01 | 1.69 | N/A | 0.988 |

### Effect of Hydrogel Geometry

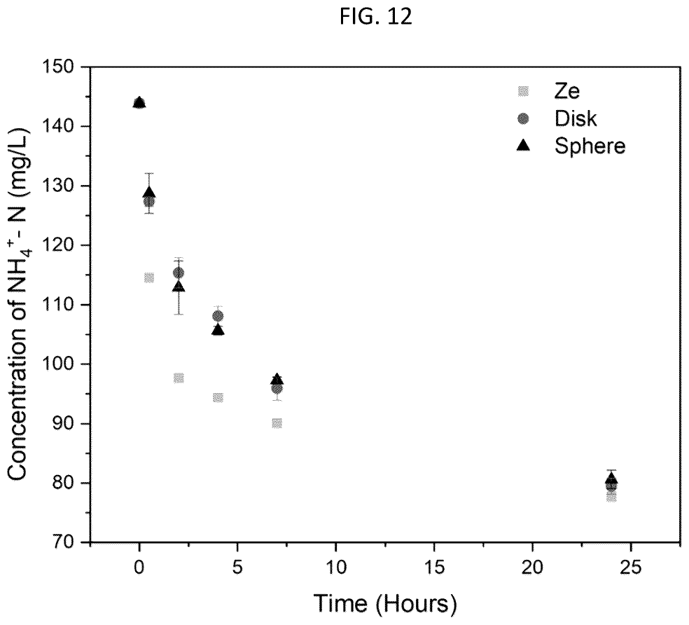

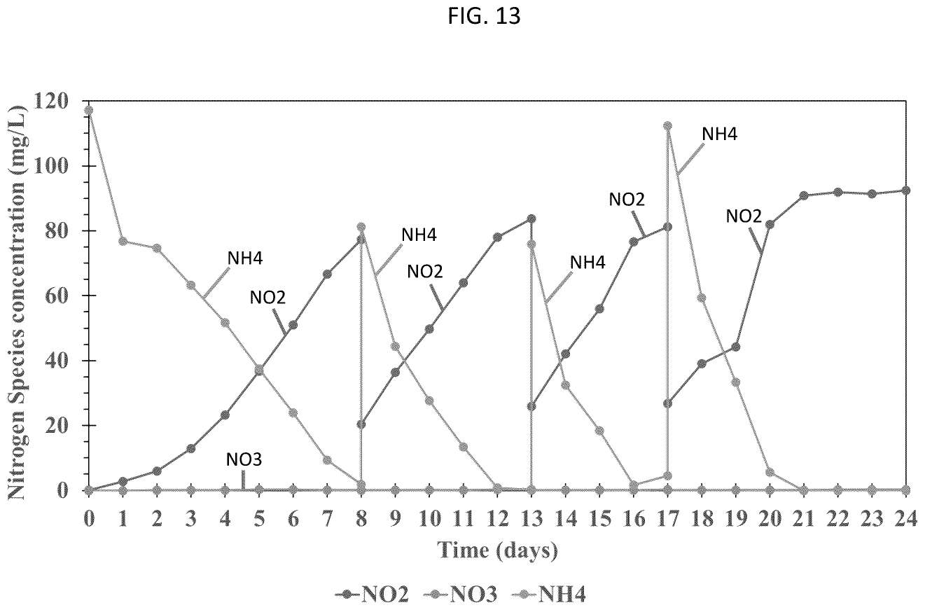

No significant difference in performance was observed between the spherical hydrogels and the disk hydrogels as shown in FIG. 12, although the spherical hydrogel carriers were smaller than the disk carriers. This is due to the surface area to volume ratio of the carriers being so close despite the sphere's smaller dimension, as shown in Table 4. Spheres may be preferred for their reduced space when being packed in reactors. The crushed zeolite without the hydrogel carrier indicated by (ze) in FIG. 12, shows a faster adsorption rate of the ammonium ions than when it is encapsulated inside of the disk hydrogel carriers as well as the spherical hydrogel carriers. This difference is due to the added layer of the PVA-SA that the ammonium ions must diffuse through before being adsorbed onto the chabazite. The experiment was repeated three times and the ammonium concentration of the disk hydrogels at 24 hours was 79 mg/L±1.2 mg/L while the sphere carriers were 80.6 mg/L±1.6 mg/L at 24 hours. The low standard deviation indicates good repeatability in performance of the fabricated carriers.

TABLE 4
Dimensions of sphere and disk carriers

| Geometry | SA (cm²) | Volume (cm³) | SA:V | Radius (cm) |
|---|---|---|---|---|
| Sphere | 40 | 12 | 3.3 | 0.9 |
| Disk | 36 | 11 | 3.2 | 2.0 |

Batch Test with AOM Outside the Disk Carrier

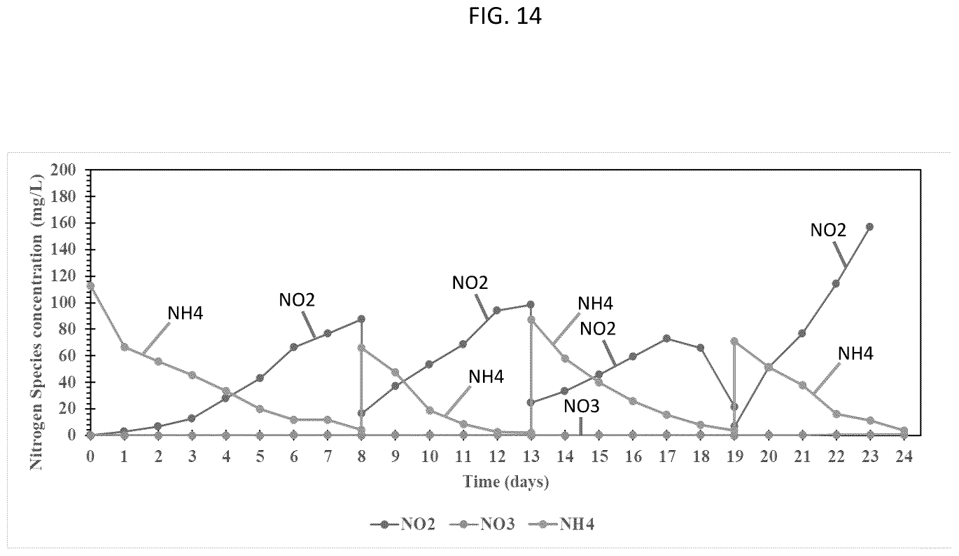

The results of the batch experiment that was done to compare the AOM outside of the carrier with encapsulated chabazite are shown in FIG. 13. As the ammonium was adsorbed onto the zeolite, the ammonium concentration in the reactor decreases and then as the AOM bacteria utilizes the ammonium, nitrite is produced. The nitrate concentration remains low throughout these cycles. This indicates that NOB microbes were suppressed due to the low dissolved oxygen concentration that was maintained throughout the experiment. In this experiment when the ammonium concentration in the reactor reached below 10% of its initial concentration, it was replaced with new groundwater feed solution. The longest cycle time to reduce the ammonium concentration was during the first cycle. This can be seen in FIG. 14, which shows the nitrogen species concentration for the reactor with the AOM and crushed zeolite only (no carrier). FIG. 14 also showed a higher nitrite production concentration at the end of the cycle as compared to the reactor using the AOM and hydrogel. This may be due to the decline in biomass population in the jar test using only chabazite and AOM. The nitrate concentration for the jar containing AOM and chabazite only, indicates the suppression of NOB since there was no increase in the nitrate concentration.

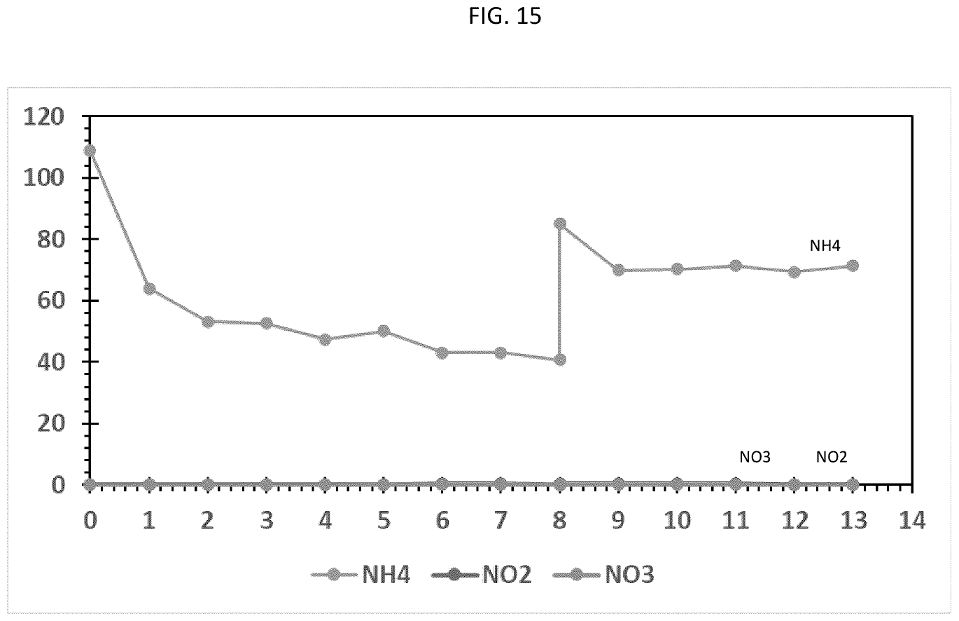

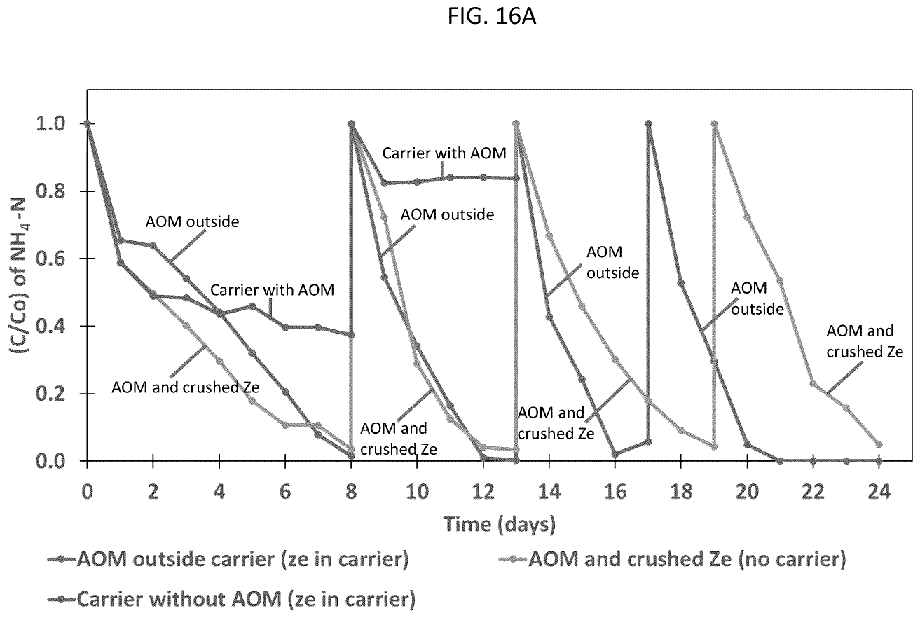

The concentration of the nitrogen species for the reactor containing the chabazite encapsulated inside the PVA-SA carrier without any AOM is shown in FIG. 15. There was a negligible nitrite concentration due to no AOM activity. There is also low nitrate concentration due to the suppression of NOB. The ammonium concentration becomes almost constant in the second cycle due to the chabazite becoming saturated and, without bioregeneration, the chabazite is unable to adsorb the remaining ammonium ions.

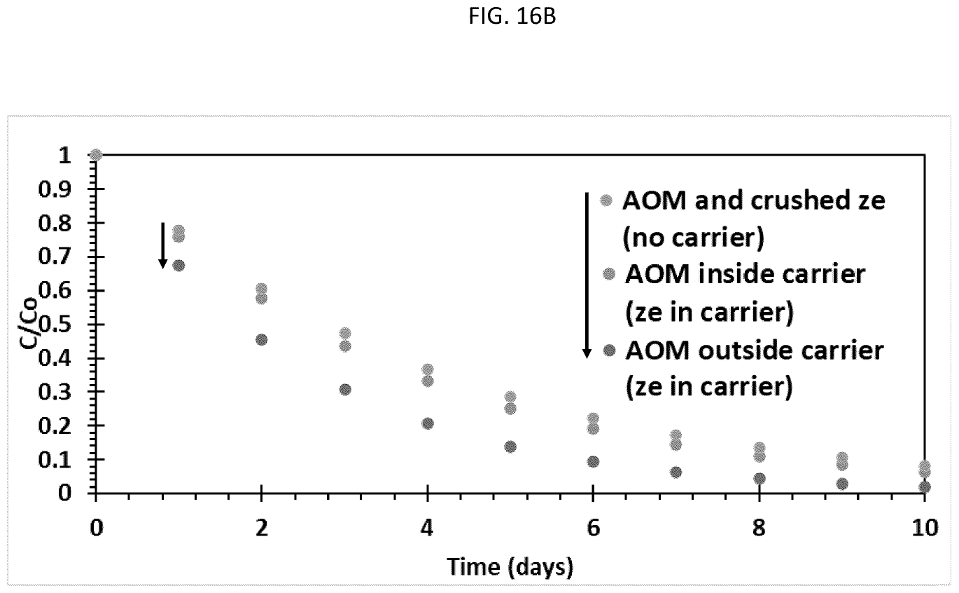

A comparison of ammonium removal for each reactor in the batch experiment is shown in FIG. 16A. The results show that the first cycle for both reactors containing AOM was the longest and the ammonium removal period decreased for the subsequent cycles in the reactor containing the AOM and carrier with encapsulated chabazite. The reactor containing the AOM, and carrier decreased from 8 days in the first cycle to 3 days in the last two cycles. The reactor with the AOM and crushed chabazite however decreased only to about 5 days in its last two cycles. This demonstrates a more efficient ammonium removal using the hydrogel carriers and may be due to the carrier promoting higher biomass and biofilm growth. The reactor with the carrier and encapsulated chabazite, (carrier without AOM) showed a significantly slower removal rate as the removal was only due to the adsorption the chabazite and in the second cycle of this reactor, (carrier without AOM) there is some initial adsorption but then the ammonium concentration remains constant showing that the chabazite inside the carrier was saturated.

More specifically, FIG. 16A shows the results from an initial (1 L) AOM batch test with PVA-SA carriers and crushed zeolite. A zeolite only reactor (no AOM) was used as a control for abiotic NH₄⁺ removal. The adsorption rate was faster with PVA-SA hydrogel carriers with encapsulated zeolite as the cycles became shorter and the removal rate faster with each consecutive cycle. The results indicate that the biofilm was growing faster on the PVA-SA carriers, possibly due to better attachment of the biofilm to the carrier surface than for the raw zeolite. Three cases were further explored in smaller sized reactors (250 mL): 1) zeolite and AOM encapsulated inside the hydrogel carrier, 2) zeolite encapsulated inside the carrier and the AOM on the outside of the carrier and 3) crushed zeolite and AOM (no carriers). The study was done in duplicate at 22° C. on a shaker table at 100 RPM. The experiment was carried out over several cycles and the NH₄⁺ adsorption rates from the most representative cycles after the acclimation period are compared in FIG. 16B. The results show that the reactors where the AOM was on the outside of the carrier and the zeolite was encapsulated inside the carrier had the fastest adsorption rate. The second fastest ammonium adsorption rate was achieved when using the carriers with both the AOM and zeolite encapsulated.

Batch Test with AOM Inside the Disk Carrier

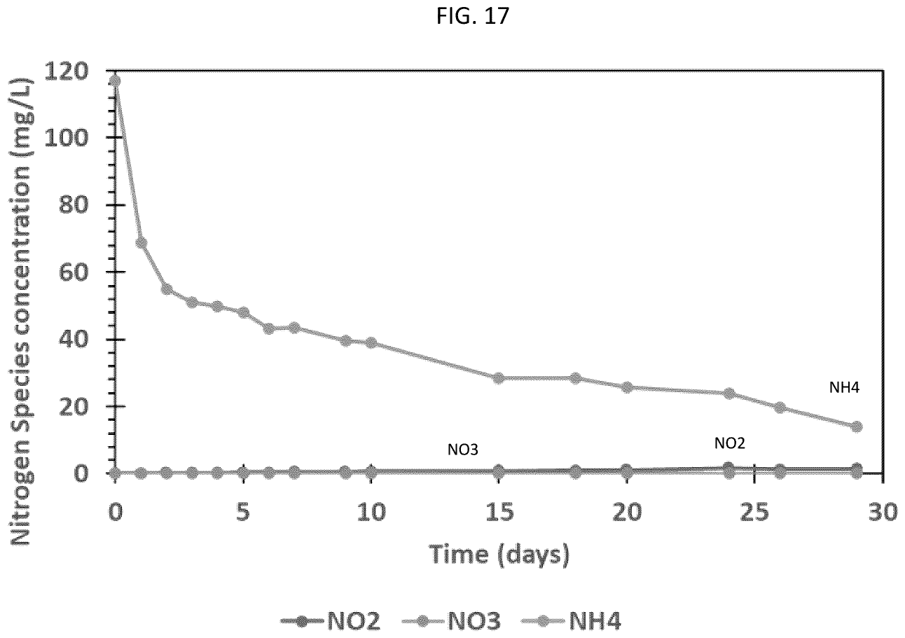

A batch experiment was done to investigate ammonium removal when using the hydrogel disk carriers with encapsulated chabazite and also encapsulating the AOM inside of the carrier. This method of encapsulating the microbes and using it as a biofilm carrier was previously used in PVA-SA hydrogel beads and showed good results for ammonium removal without the use of zeolite (Landreau et al., 2020). Therefore, it was hypothesized to work better in the disk carriers. However, when the experiment was done using the jar tester, the ammonium removal was very slow and showed almost no nitrite production indicating that the microbes may have died. These results can be seen in FIG. 17.

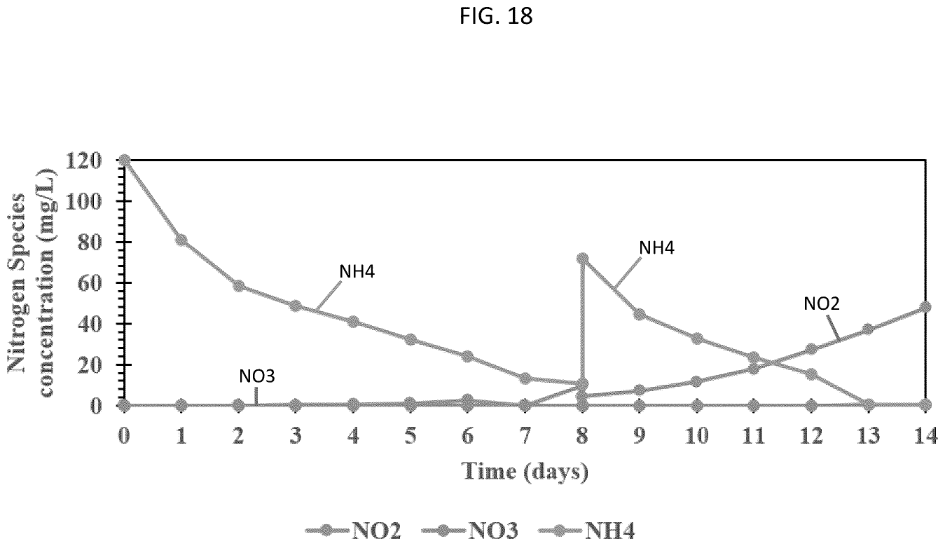

A scaled down test was done using the carrier with AOM and chabazite inside of the carrier and the results are shown in FIG. 18. The graph shows that the ammonium concentration was decreased in 8 days which was similar to the batch tests where the AOM were on the outside of the carrier as well as when the AOM was used with the chabazite only. FIG. 18 also shows a significant increase in nitrite production unlike the scaled-up batch test where the AOM was encapsulated. The small-scale test was repeated twice with similar results.

The small-scale test was done in an Erlenmeyer flask on the shaker and the scaled-up test was done in the jar tester, but further research is needed to look into this issue. The carriers used in the jar tester were added to deionized water before being placed in the groundwater in the jar tester. This may have caused the microbes to die due to the low salt concentration and may be the reason there was only a small amount of nitrite observed during the test.

### Polyethylene Carriers

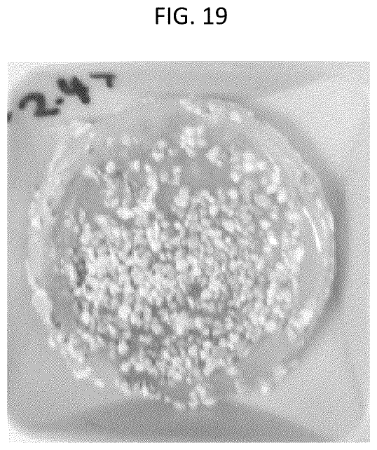

Polyethylene was used to embed the chabazite to create biofilm carriers by mixing polyethylene powder with the chabazite (unmodified) and then heating inside of a disk mold at 120° C. for 30 mins and then pressing onto the mold to embed the chabazite. This method was not effective as there was some loss of the chabazite during the pressing process and some of the chabazite would not be completely embedded after the polyethylene was cooled causing them to fall off of the carrier after the polyethylene was cooled. It was also difficult to evenly distribute the chabazite on the polyethylene carrier due to their larger size compared to the polyethylene powder. FIG. 19 shows the polyethylene carrier made using this method.

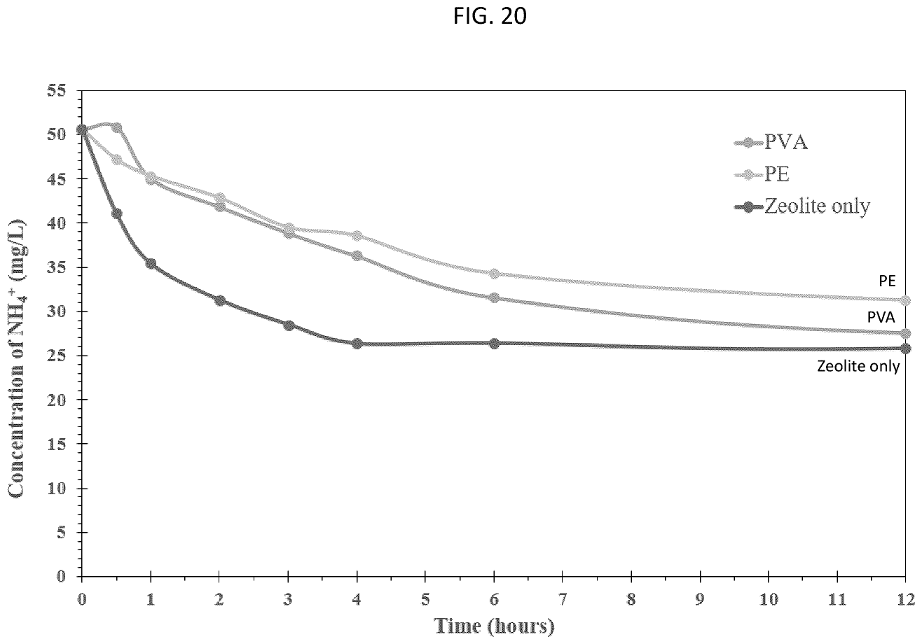

An experiment was done to show the performance of the polyethylene carrier with the performance of the PVA-SA hydrogel disk carriers using 0.5 g of unmodified chabazite in each carrier. The results are shown in FIG. 20. The results show that overall, the hydrogel carrier performed better. This may be due mainly to the loss of some of the chabazite surface area when it is embedded into the polyethylene carrier. The chabazite was not evenly distributed on the carrier and may have also contributed to the lower ammonium removal performance.

### CONCLUSIONS

This work demonstrated fabrication of a biofilm carrier that incorporated chabazite and promoted biofilm growth. This work also evaluated the ammonium removal performance due to (1) the ion exchange process of the carrier (abiotic) and (2) the combined ion exchange and bioregeneration process (biotic) to determine the effectiveness of the biofilm carrier.

PVA-SA hydrogel biofilm carriers were fabricated with encapsulated chabazite. The particle size of the chabazite was reduced from 1-2 mm to 0.1-0.4 mm to determine its effect on the ammonium removal rate of the carrier. The results showed that decreasing the chabazite particle size inside of the hydrogel biofilm carrier helped to increase the rate of ammonium removal in wastewater treatment due to the increased surface area. The reduction in particle size was also preferred because they were distributed more evenly throughout the carrier due to the lighter weight of each particle. This study helped to optimize the carrier's performance and can be improved in future work by reducing the particle size of the chabazite even smaller than 0.1 mm to further optimize the carrier's ammonium adsorption rate.

Changing the geometry of the hydrogel biofilm carrier was also investigated, by fabricating disk and sphere hydrogel carriers. The ion exchange process using the disk and sphere carriers were evaluated showing equivalent adsorption rates due to their similar surface area to volume ratios. This work can be further improved by using the fabrication methods in this work to make other carrier shapes to improve the surface area to volume ratio or to optimize aeration in column studies. The next step could be fabricating multi-faceted shaped hydrogel carriers using custom made molds to increase the surface area.

Isotherm and kinetic models were developed for the disk hydrogels, and they were found to be better fitted to the PSO kinetic models with an R² squared value of 0.978. The isotherm models show that the Freundlich model was better fitted with an R² squared value of 0.987.

Batch tests were done to investigate the disk-shaped carrier's ammonium removal performance when the chabazite inside the hydrogel was bioregenerated with AOM. There was a higher ammonium removal in the batch tests that included the PVA-SA biofilm carriers and AOM on the outside compared to the tests that used only AOM and chabazite (without the carrier). The results showed that the cycle was the shortest when using the AOM and fabricated disk carriers since the cycle time was reduced to 3 days while the batch test with the AOM and chabazite was only reduced to 5 days. The batch test with only the disk hydrogel carriers (no AOM) were unable to move past the second cycle, showing the effect of bioregeneration of the chabazite in the hydrogel disk carrier and how the adsorption is improved with the microbes.

The hydrogel carriers with AOM encapsulated inside along with the chabazite did not show bioregeneration of the zeolite when done on the large scale but did show bioregeneration when done on the small scale. The cycle time in the small-scale test, reduced from 8 days in the first cycle to 5 days in the second cycle. This difference in performance may be due to the carriers being placed in deionized water to remove the excess barium chloride solution for a longer period on the large-scale test than on the small-scale test causing the cells to burst (cytolysis.) from a low salt concentration.

Thus, the fabricated PVA-SA carriers with encapsulated zeolite can be used as biofilm carriers in wastewater treatment when combined with AOM on the outside of the carrier for bioregeneration.

### Example 2

This example demonstrates that ion exchange and deammonification can be combined to achieve sustainable ammonium removal from mainstream wastewater. Conventional biological nitrogen removal (BNR) processes typically require a high energy demands to provide oxygen for nitrification and high chemical demands to provide organic carbon for denitrification. Biological deammonification is a novel BNR process that combines partial nitritation (NH₄⁺→NO₂⁻) with anaerobic ammonium oxidation (anammox; NH₄⁺+NO₂⁻→N₂) (Ergas and Aponte-Morales, 2014). The combined partial nitritation/anammox (PN/A) process considerably reduces the oxygen and organic carbon requirements at full-scale wastewater treatment plants (WWTPs). Therefore, deammonification is promising as a more sustainable BNR alternative with lower energy and chemical requirements than conventional BNR (Cao et al., 2017). In preliminary studies (such as the IX-PN/A process described herein), raw zeolite was used without being embedded or encapsulated in a hydrogel carrier. Based on validating data, similar processes can be implemented using composite material with zeolite embedded or encapsulated in hydrogel carriers, including the composite of a PVA-SA carrier with encapsulated zeolite (e.g., chabazite), as described herein.

Implementation of deammonification has been successful for treatment of high-ammonium strength wastewaters, such as sidestreams from anaerobic digestion process. Full-scale sidestream PN/A plants are in operation in the US, Europe, and Australia (Bailey et al., 2018). Elevated ammonium concentrations result in high free ammonia concentrations, which are suitable to inhibit competitor microbes that otherwise interfere with the PN/A process. However, typical domestic (mainstream) wastewater has a much lower ammonium (and free ammonia) content, making the PN/A process challenging to implement and control (Anthonisen et al., 1976). To date, there are no reported full-scale mainstream PN/A plants operating worldwide (Izadi et al., 2021).

A strategy was implemented for concentrating ammonium on chabazite, a natural zeolite mineral with a high ion exchange (IX) capacity and selectivity for ammonium ions. In this process, large volumes of mainstream wastewater were allowed to pass through a chabazite media bed until saturation was reached. Subsequently, the mineral was bioregenerated via PN/A by microbial biofilms attached to the chabazite surface that consume ammonium. The bioregeneration process allows chabazite to be reused for many treatment cycles without having to add fresh zeolite or regenerant brines (Aponte-Morales et al., 2016, 2018).

The IX-PN/A process can be implemented in a single-stage for ammonium removal from mainstream wastewater. Specific studies can be conducted to a) evaluate whether chabazite is effective in concentrating ammonium and providing the environmental conditions needed for PN/A, b) demonstrate that the microbes involved in deammonification can bioregenerate chabazite for reuse over many IX-PN/A cycles, and c) identify the diversity among the microbial community governing the IX-PN/A process.

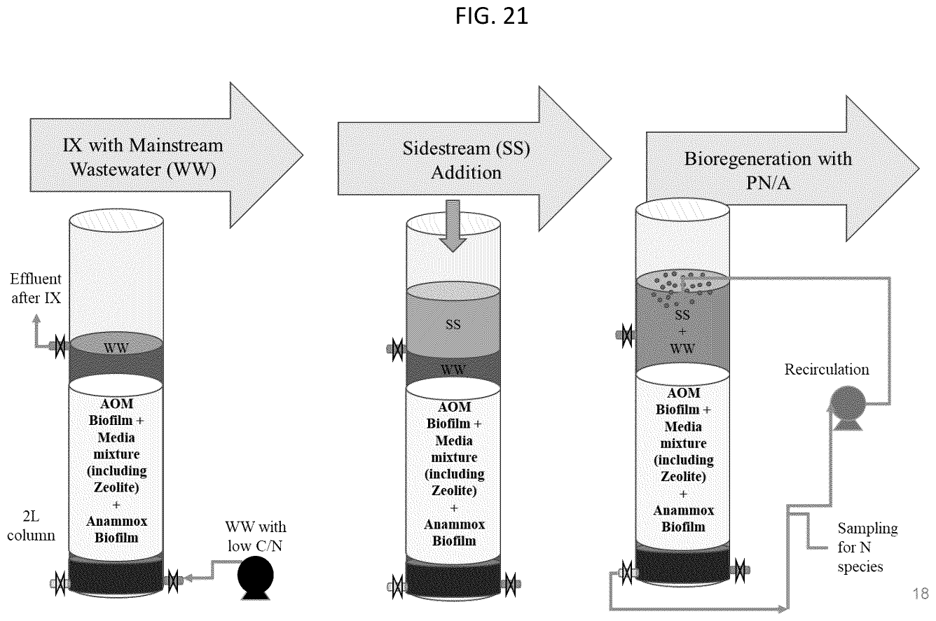

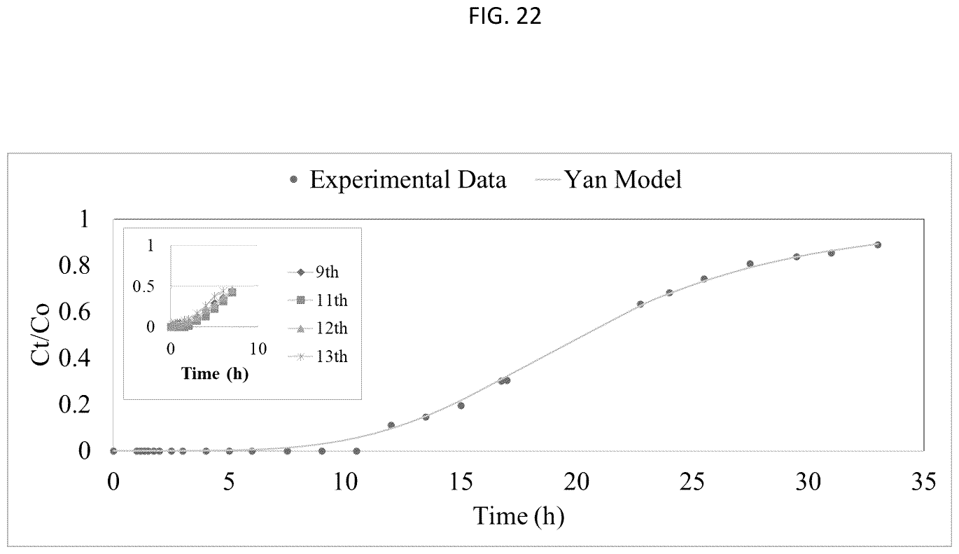

Methodology A 2-L sequencing batch biofilm reactor (SBBR) filled with an adsorptive medium containing chabazite was used to conduct IX-PN/A as a single process (FIG. 21). Once the IX process reached a complete breakthrough curve (C_{effluent}/C_{influent}≈100%) (FIG. 22), the reactor was inoculated with biofilms from PN/A enriched cultures, and bioregeneration was initiated by applying recirculation to provide aeration and aid mass transfer. The steps in a typical IX-PN/A treatment cycle consisted of IX, sidestream addition, and bioregeneration (by PN/A) (FIG. 21). During IX, the IX-PN/A bioreactor was fed with mainstream wastewater (˜40 mg/L ammonium as nitrogen) using variable feeding rates (22-34 mL/min) to reach a target breakpoint. Sodium and ammonium concentrations were measured using Standard Method 3500 (APHA) by Metrohm 881 Compact IC Pro Ion Chromatography. Subsequently, synthetic sidestream (˜500 mg/L ammonium as nitrogen) was added to ensure a high free ammonia content in the liquid phase to favor conditions for PN/A. During bioregeneration, samples were taken periodically to measure ammonium, nitrite, and nitrate concentrations over time and determine the nitrogen removal and zeolite bioregeneration. Measurements of nitrogen species (NH₄⁺, NO₂⁻, and NO₃⁻) and other ion species (Na⁺, SO₄²⁻, and PO₄³⁻) concentrations were done by chromatography. The pH, temperature, turbidity, and concentrations of dissolved oxygen, sulfide, and chemical oxygen demand (COD) were measured by the end of each IX-PN/A cycle following APHA Standard Methods.

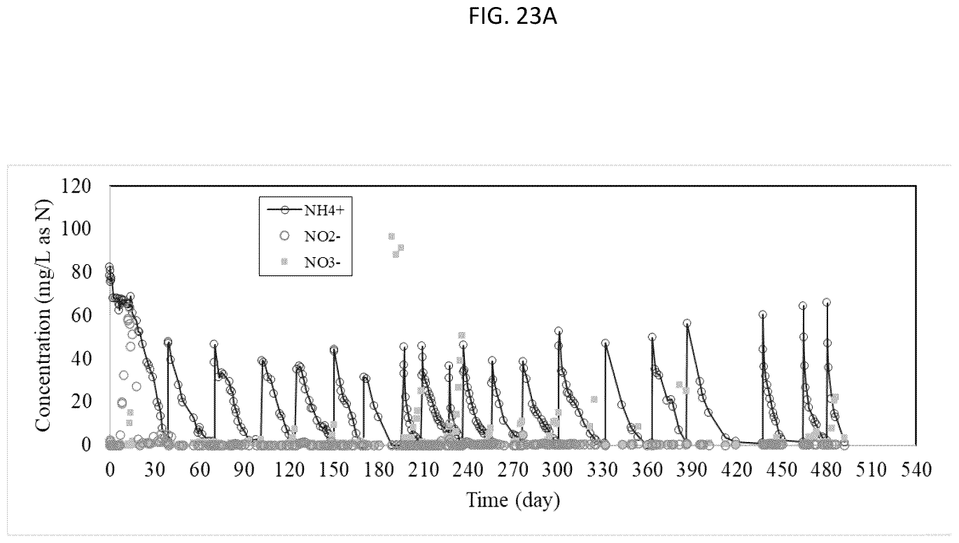

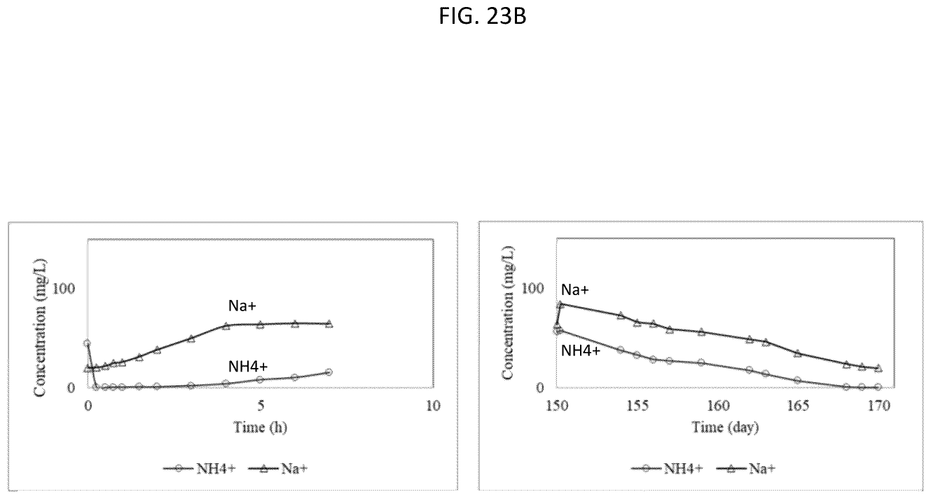

Results and Discussion During the IX stage, chabazite successfully removed large ammonium loads from low ammonia-strength wastewater. During a typical IX cycle, ammonium was removed from mainstream wastewater until a breakpoint of C_{effluent}/C_{influent}≈30-40% was achieved (FIG. 22, inserted panel). During the bioregeneration stage, the ammonium concentration in the effluent typically reached <1 mg/L (as N) due to the activity of PN/A microorganisms. At the end of the bioregeneration stage, the chabazite was ready to start the next IX-PN/A treatment cycle (FIG. 23A). The single-stage IX-PN/A was operated for twelve to twenty treatment cycles (about 250 to 500 days), during which the ion exchange material (chabazite) was effectively bioregenerated. Sodium and ammonium profiles over a typical cycle are shown in FIG. 23B. During IX, ammonium capture was accompanied by sodium release, which slowed as the chabazite reached saturation. During bioregeneration, microbial ammonium uptake from the chabazite surface was accompanied by sodium adsorption from the liquid phase onto the surface, providing exchangeable sodium ions for the following IX-PN/A cycle.

The microbial basis on which the IX-PN/A process relied was that ammonium concentration progressively decreased due to the activity of ammonia-oxidizing microorganisms (AOM) and anammox bacteria, with suppression of competitor nitrite-oxidizing bacteria (NOB). Some NOB activity and nitrate accumulation was observed in some treatment cycles (FIG. 23A) with high recirculation rates provided for microbial detachment and sampling. Microbial analysis by polymerase chain reaction (PCR) also confirmed the existence of AOM and anammox bacteria through the IX-PN/A column.

In conclusion, deammonification, or partial nitritation/anammox (PN/A), is a novel BNR technology with lower energy and chemical requirements than conventional BNR. Bioregeneration of chabazite with PN/A eliminates the need for chemical regenerant inputs, replacement with fresh media, or brine waste production. As the natural chabazite is reused for many treatment cycles, this process offers a sustainable strategy for a circular economy. In addition, coupling IX with PN/A is an innovative, effective BNR for mainstream wastewater, with lower costs, environmental impacts, and carbon footprint. Additional studies can be carried to a) identify the effect of operating conditions on PN/A performance through experimental and modeling studies and b) compare system performance with different strategies for biofilm formation, including for example naturally formed PN/A biofilm, chabazite-coated biocarriers for attached biofilm growth, or biocoatings encapsulating PN/A microbes.

### REFERENCES

ADDIN EN.REFLIST Agbovi, H. K., & Wilson, L. D. (2021). 1—Adsorption processes in biopolymer systems: fundamentals to practical applications. In S. Kalia (Ed.), Natural Polymers-Based Green Adsorbents for Water Treatment (pp. 1-51). Elsevier. https://doi.org/https://doi.org/10.1016/B978-0-12-820541-9.00011-9
Ahmed, E. M. (2015). Hydrogel: Preparation, characterization, and applications: A review. Journal of Advanced Research, 6(2), 105-121. https://doi.org/10.1016/j.jare.2013.07.006
Alvarez, S., Brown, C. E., Diaz, M. G., O'Leary, H., Solis, D. (2024). Non-linear impacts of harmful algae blooms on the coastal tourism economy. Journal of Environmental Management. Volume 351. 119811.
Andreottola, G., Foladori, P., Ragazzi, M., & Tatano, F. (2000). Experimental comparison between MBBR and activated sludge system for the treatment of municipal wastewater. Water science and technology, 41(4-5), 375-382.
Anthonisen, A. C., Loehr, R. C., Prakasam, T. B. S., and Srinath, E. G. (1976). Inhibition of nitrification by ammonia and nitrous acid. Journal (Water Pollution Control Federation), 835-852.
Aponte-Morales, V. E. (2015). Ammonium Removal from High Strength Wastewater Using a Hybrid Ion Exchange Biological Process[Dissertation, University of South Florida].
Aponte-Morales, V. E., Tong, S., & Ergas, S. J. (2016). Nitrogen removal from anaerobically digested swine waste centrate using a laboratory-scale chabazite-sequencing batch reactor. Environmental Engineering Science, 33(5), 324-332.
Aponte-Morales, V. E., Payne, K. A., Cunningham, J. A., & Ergas, S. J. (2018). Bioregeneration of chabazite during nitrification of centrate from anaerobically digested livestock waste: Experimental and modeling studies. Environmental science & technology, 52(7), 4090-4098.
Bailey, E. L., Bilyk, K., Hanna, A., & Wankmuller, D. (2018). Evaluation of Sidestream Deammonification Process Enhancements for Treating High Strength Filtrate at the City of Raleigh's Neuse River Resource Recovery Facility. Proc. Water Environ. Fed., 2018, 5286-5307.
Burkholder, J. M., Tomasko, D. A., & Touchette, B. W. (2007). Seagrasses and eutrophication. Journal of Experimental Marine Biology and Ecology, 350(1-2), 46-72. https://doi.org/10.1016/j.jembe.2007.06.024
Cao, C. Y., & Zhao, Y. H. (2012). The Comparison of MBBR and ASP for Treatment on Petrochemical Wastewater. Petroleum Science and Technology, 30(14), 1461-1467. https://doi.org/10.1080/10916466.2010.506458
Cao, Y., van Loosdrecht, M., and Daigger, G. T. (2017). Mainstream partial nitritation-anammox in municipal wastewater treatment: status, bottlenecks, and further studies. Applied microbiology and biotechnology, 101(4), 1365-1383.
Chattopadhyay, I., Banu, J. R., Usman, T. M. M., & Varjani, S. (2022). Exploring the role of microbial biofilm for industrial effluents treatment. Bioengineered, 13(3), 6420-6440. https://doi.org/10.1080/21655979.2022.2044250
Chero-Osorio, S. (2022). Carbon Diversion, Partial Nitritation/Anammox Enrichment, and Ammonium Capture as Initial Stages for Mainstream Ion Exchange-Deammonification Process University of South Florida].
Cullen-Unsworth, L., & Unsworth, R. (2013). Seagrass Meadows, Ecosystem Services, and Sustainability. Environment: Science and Policy for Sustainable Development, 55(3), 14-28. https://doi.org/10.1080/00139157.2013.785864
de la Cruz, A., Logsdon, R., Lye, D., Guglielmi, S., Rice, A., & Kannan, M. S. (2017). Harmful Algae Bloom Occurrence in Urban Ponds: Relationship of Toxin Levels with Cell Density and Species Composition. J Earth Environ Sci, 25, 704-726. https://doi.org/10.29011/jees-148.100048
Ergas, S. J., and Aponte-Morales, V. (2014). Biological Nitrogen Removal. Comprehensive Water Quality and Purification: Vol. 3 Remediation of Polluted Waters, S. Sengupta Ed., Elsevier.
Gao, D., Li, Y., & Liang, H. (2022). Biofilm carriers for anaerobic ammonium oxidation: Mechanisms, applications, and roles in mainstream systems. Bioresource Technology, 353, 127115. https://doi.org/https://doi.org/10.1016/j.biortech.2022.127115
Islam, M. A., Chowdhury, M. A., Mozumder, M. S. I., & Uddin, M. T. (2021). Langmuir Adsorption Kinetics in Liquid Media: Interface Reaction Model. ACS Omega, 6(22), 14481-14492. https://doi.org/10.1021/acsomega.1c01449
Izadi, P., Izadi, P., & Eldyasti, A. (2021). Towards mainstream deammonification: Comprehensive review on potential mainstream applications and developed sidestream technologies. Journal of Environmental Management, 279, 111615.
Lahav, O., & Green, M. (2000). Bioregenerated ion-exchange process: The effect of the biofilm on ion-exchange capacity and kinetics. Water Sa, 26(1), 51-57.
Landreau, M., Byson, S. J., You, H., Stahl, D. A., & Winkler, M. K. H. (2020). Effective nitrogen removal from ammonium-depleted wastewater by partial nitritation and anammox immobilized in granular and thin layer gel carriers. Water Research, 183. https://doi.org/ARTN 116078 10.1016/j.watres.2020.116078
Lariyah, M. S., Mohiyaden, H. A., Hayder, G., Hayder, G., Hussein, A., Basri, H., Sabri, A. F., & Noh, M. N. (2016). Application of Moving Bed Biofilm Reactor (MBBR) and Integrated Fixed Activated Sludge (IFAS) for Biological River Water Purification System: A Short Review. IOP Conference Series: Earth and Environmental Science, 32(1), 012005. https://doi.org/10.1088/1755-1315/32/1/012005
Lee, K. S., Kwon, T.-H., Park, T., & Jeong, M. S. (2020). Chapter 2—Microbiology and Microbial Products for Enhanced Oil Recovery. In K. S. Lee, T.-H. Kwon, T. Park, & M. S. Jeong (Eds.), Theory and Practice in Microbial Enhanced Oil Recovery (pp. 27-65). Gulf Professional Publishing. https://doi.org/https://doi.org/10.1016/B978-0-12-819983-1.00002-8
Ma, B., Bao, P., Wei, Y., Zhu, G. B., Yuan, Z. G., & Peng, Y. Z. (2015). Suppressing Nitrite-oxidizing Bacteria Growth to Achieve Nitrogen Removal from Domestic Wastewater via Anammox Using Intermittent Aeration with Low Dissolved Oxygen. Scientific Reports, 5. https://doi.org/ARTN 13048 10.1038/srep13048
Mahto, K. U., & Das, S. (2022). Bacterial biofilm and extracellular polymeric substances in the moving bed biofilm reactor for wastewater treatment: A review. Bioresource Technology, 345. https://doi.org/10.1016/j.biortech.2021.126476
Malovanyy, A., Trela, J., & Plaza, E. (2015). Mainstream wastewater treatment in integrated fixed film activated sludge (IFAS) reactor by partial nitritation/anammox process. Bioresource Technology, 198, 478-487. https://doi.org/10.1016/j.biortech.2015.08.123
Morteza, B., Naimeh, M., & Mehdi, M. (2016). An Introduction to Hydrogels and Some Recent Applications. In M. Sutapa Biswas (Ed.), Emerging Concepts in Analysis and Applications of Hydrogels (pp. Ch. 2). IntechOpen. https://doi.org/10.5772/64301
Prajapati, J. C., Syed, H. S., & Chauhan, J. (2014). Removal of Ammonia from wastewater by ion exchange technology. Int J Innovative Res Techno, 1(9).
Priyantha, N., Lim, L., Dahri, M. K., & Tennakoon, D. T. B. (2013). Dragon Fruit Skin as a Potential Low-Cost Biosorbent for the Removal of Manganese(II) Ions. Journal of Applied Sciences in Environmental Sanitation, 8, 179-188.
Qiu, T., Zeng, Y., Ye, C., & Tian, H. (2012). Adsorption Thermodynamics and Kinetics of <i>p</i>-Xylene on Activated Carbon. Journal of Chemical &amp; Engineering Data, 57(5), 1551-1556. https://doi.org/10.1021/je300138a
Rice, E. W., Bridgewater, L., & Association, A. P. H. (2012). Standard methods for the examination of water and wastewater (Vol. 10). American public health association Washington, DC.
Saini, S., Tewari, S., Dwivedi, J., & Sharma, V. (2023). Biofilm-mediated wastewater treatment: a comprehensive review. Materials Advances, 4(6), 1415-1443. https://doi.org/10.1039/d2ma00945e
Shao, Y., Yang, S., Mohammed, A., & Liu, Y. (2018). Impacts of ammonium loading on nitritation stability and microbial community dynamics in the integrated fixed-film activated sludge sequencing batch reactor (IFAS-SBR). International Biodeterioration & Biodegradation, 133, 63-69. https://doi.org/https://doi.org/10.1016/j.ibiod.2018.06.002
Shore, J. L., M'Coy, W. S., Gunsch, C. K., & Deshusses, M. A. (2012). Application of a moving bed biofilm reactor for tertiary ammonia treatment in high temperature industrial wastewater. Bioresource Technology, 112, 51-60. https://doi.org/https://doi.org/10.1016/j.biortech.2012.02.045
Shumway, S. E. (1990). A Review of the Effects of Algal Blooms on Shellfish and Aquaculture. Journal of the World Aquaculture Society, 21(2), 65-104. https://doi.org/10.1111/j.1749-7345.1990.tb00529.x
Song, M., Yan, T., Kong, F., Wang, Y., & Zhou, M. (2022). Increased diversity and environmental threat of harmful algal blooms in the Southern Yellow Sea, China. Journal of Oceanology and Limnology, 40(6), 2107-2119. https://doi.org/10.1007/s00343-021-1209-4
Verma, S., Kuila, A., & Jacob, S. (2022). Role of Biofilms in Waste Water Treatment. Applied Biochemistry and Biotechnology. https://doi.org/10.1007/s12010-022-04163-5
Wahyudi, A. A. J., Rahmawati, S., Irawan, A., Hadiyanto, H., Prayudha, B., Hafizt, M., Afdal, A., Adi, N. S., Rustam, A., Hernawan, U. E., Rahayu, Y. P., Iswari, M. Y., Supriyadi, I. H., Solihudin, T., Ati, R. N. A., Kepel, T. L., Kusumaningtyas, M. A., Daulat, A., Salim, H. L., . . . Kiswara, W. (2020). Assessing Carbon Stock and Sequestration of the Tropical Seagrass Meadows in Indonesia. Ocean Science Journal, 55(1), 85-97. https://doi.org/10.1007/s12601-020-0003-0
Weralupitiya, C., Wanigatunge, R., Joseph, S., Athapattu, B. C. L., Lee, T. H., Biswas, J. K., Ginige, M. P., Lam, S. S., Kumar, P. S., & Vithanage, M. (2021). Anammox bacteria in treating ammonium rich wastewater: Recent perspective and appraisal. Bioresource Technology, 334. https://doi.org/ARTN 125240 10.1016/j.biortech.2021.125240
Winiwarter, W., Erisman, J. W., Galloway, J. N., Klimont, Z., & Sutton, M. A. (2013). Estimating environmentally relevant fixed nitrogen demand in the 21st century. Climatic Change, 120(4), 889-901. https://doi.org/10.1007/s10584-013-0834-0
Winkler, M. K. H., & Straka, L. (2019). New directions in biological nitrogen removal and recovery from wastewater. Current Opinion in Biotechnology, 57, 50-55. https://doi.org/10.1016/j.copbio.2018.12.007
Wurtsbaugh, W. A., Paerl, H. W., & Dodds, W. K. (2019). Nutrients, eutrophication and harmful algal blooms along the freshwater to marine continuum. Wiley Interdisciplinary Reviews—Water, 6(5). https://doi.org/ARTN e1373 10.1002/wat2.1373
Zhao, J., Fang, S. B., Liu, G., Qi, W. X., Bai, Y. H., Liu, H. J., & Qu, J. H. (2022). Role of ammonia-oxidizing microorganisms in the removal of organic micropollutants during simulated riverbank filtration. Water Research, 226. https://doi.org/ARTN 119250 10.1016/j.watres.2022.119250
Zhao, Y. X., Liu, D., Huang, W. L., Yang, Y., Ji, M., Nghiem, L. D., Trinh, Q. T., & Tran, N. H. (2019). Insights into biofilm carriers for biological wastewater treatment processes: Current state-of-the-art, challenges, and opportunities. Bioresource Technology, 288. https://doi.org/ARTN 121619 10.1016/j.biortech.2019.121619

### LIST OF ACRONYMS

| Acronym | Definition |
|---|---|
| AOM | Ammonium-oxidizing microorganisms |
| AOB | Ammonium oxidizing bacteria |
| BNR | Biological nitrogen removal |
| EPS | Extracellular polymeric substances |
| NOB | Nitrite oxidizing bacteria |
| PVA | Polyvinyl alcohol |
| SA | Sodium alginate |
| PVA-SA | Polyvinyl Alcohol-Sodium alginate |
| MBBR | Moving bed biofilm reactor |
| IFAS | Integrated fixed film activated sludge |
| PN/A | Partial nitritation and anammox |

1. A composite comprising a polymeric hydrogel and an ammonium exchange zeolite attached to the hydrogel, wherein the polymeric hydrogel comprises polyvinyl alcohol (PVA) and a second polymer component selected from the group consisting of sodium alginate (SA), polyacrylamide (PAM), chitosan, gelatin, carrageenan, polyurethane, poly(lactic acid), poly(N-isopropylacrylamide) (PNIPAAm), polyethylene glycol, polyacrylic acid (PAA), and polyvinylpyrrolidone (PVP).

2. The composite of claim 1, wherein the second polymer component is sodium alginate.

3. The composite of claim 1, wherein the ammonium exchange zeolite is encapsulated in the polymeric hydrogel.

4. The composite of claim 3, wherein the composite has a shape selected from spherical, cylindrical, ring-shaped, hexagonal, star, disc-shaped, spiral, helical, tetrahedral, octahedral, pyramidal, or prismatic.

5. (canceled)

6. (canceled)

7. The composite of claim 4, wherein the polymeric hydrogel has a hydrogel surface area to volume ratio within a range of 2.5 to 5.0 cm²/cm³.

8. (canceled)

9. The composite of claim 1, wherein the ammonium exchange zeolite comprises analcite, apophyllite, chabazite, clinoptilolite, erionite, faujasite, heulandite, inesite, laumontite, mordenite, natrolite, phillipsite, stilbite, or a mixture thereof.

10. The composite of claim 9, wherein the ammonium exchange zeolite comprises chabazite.

11. The composite of claim 1, wherein the zeolite has an average particle size between 10 and 1000 μm.

12. (canceled)

13. The composite of claim 1, further comprising an ammonium oxidizing biofilm attached to the hydrogel.

14. The composite of claim 13, wherein the ammonium oxidizing biofilm comprises ammonium-oxidizing microorganisms (AOM), anaerobic ammonium oxidation (anammox) bacteria, or a combination thereof.

15. The composite of claim 14, wherein the ammonium-oxidizing microorganisms (AOM) comprise ammonia-oxidizing bacteria, ammonia-oxidizing archaea, or a combination thereof.

16-21. (canceled)

22. A reactor for removing ammonium ions from wastewater, comprising the composite of claim 13.

23. A reactor for removing ammonium ions from wastewater, comprising:
a polymeric hydrogel carrier;
an ammonium exchange zeolite attached to the polymeric hydrogel carrier; and
an ammonium oxidizing biofilm attached to the polymeric hydrogel carrier.

24. (canceled)

25. The reactor of claim 23, wherein the polymeric hydrogel carrier comprises polyvinyl alcohol.

26. The reactor of claim 25, wherein the polymeric hydrogel carrier further comprises sodium alginate.

27-47. (canceled)

48. A wastewater treatment system comprising the reactor of claim 22.

49. (canceled)

50. A method of treating wastewater comprising ammonium ions, the method comprising contacting the wastewater with the composite of claim 13 for a treatment duration, thereby concentration of the ammonium ions in the wastewater is reduced.

51. A method of treating wastewater comprising ammonium ions, the method comprising introducing the wastewater into the reactor of claim 22 for a treatment duration, such that the wastewater contacts the ammonium exchange zeolite and the ammonium oxidizing biofilm attached to the polymer carrier, thereby concentration of the ammonium ions in the wastewater is reduced.

52. (canceled)

53. (canceled)

54. A method of preparing a composite comprising a polymeric hydrogel and an ammonium exchange zeolite attached to the polymeric hydrogel, wherein the polymeric hydrogel comprises polyvinyl alcohol (PVA) and a second polymer component, the method comprising:
mixing the polyvinyl alcohol, the second polymer component, and the ammonium exchange zeolite in water to form a mixture; and
adding a crosslinking solution to the mixture, thereby forming the composite.

55-60. (canceled)

61. A composite prepared by the method of claim 54.
